(19) United States
(12) Patent Application Publication
(10) Pub. No.: US 2014/0291054 A1
(43) Pub. Date: Oct. 2, 2014

(54) PEDESTRIAN PROTECTION AIRBAG DEVICE

(71) Applicant: TOYODA GOSEI CO., LTD., Kiyosu-shi (JP)

(72) Inventors: Akimitsu TANAKA, Kiyosu-shi (JP); Yasushi MASUDA, Kiyosu-shi (JP); Yuji MATSUZAKI, Kiyosu-shi (JP); Hajime KITTE, Kiyosu-shi (JP)

(73) Assignee: TOYODA GOSEI CO., LTD., Kiyosu-shi (JP)

(21) Appl. No.: 14/165,903

(22) Filed: Jan. 28, 2014

(30) Foreign Application Priority Data
Mar. 29, 2013 (JP) 2013-72916
Sep. 30, 2013 (JP) 2013-204272

(51) Int. Cl. B60R 21/36

(52) U.S. Cl. CPC B60R 21/36; B60R 2021/346
USPC 180/274

(57) ABSTRACT

A pedestrian protection airbag device is mountable proximate to a rear end of a vehicle hood. An airbag includes a horizontal inflatable portion deployable over a lower region of a front windshield and a pair of vertical inflatable portions extending rearward from opposite ends of the horizontal inflatable portion for covering front surfaces of front pillars. The horizontal inflatable portion includes an upper reach region that is deployable at a front region thereof and a lower reach region deployable at the rear of the upper reach region. A gas outlet region is provided at the rear edge of the upper reach region and inward relative to the vertical inflatable portions in a left and right direction as inflated, such that an inflation gas having flown out of the upper reach region via the gas outlet region flows through the lower reach region and then flows into the vertical inflatable portions.

### CROSS REFERENCE TO RELATED APPLICATIONS

The Present application claims priority from Japanese Patent Applications No. 2013-72916 of Tanaka et al., filed on Mar. 29, 2013, and No. 2013-204272 of Tanaka et al., filed on Sep. 30, 2013, the disclosure of which are hereby incorporated into the present application by reference.

### BACKGROUND OF THE INVENTION

1. Field of the Invention

The present invention relates to a pedestrian protection airbag device that is stored in a vicinity of the rear end of a vehicle hood and includes an airbag for deployment to cover a lower area of the front windshield located at the rear of the hood and front surfaces of the left and right front pillars.

2. Description of Related Art

JP 2007-137252 A discloses a known pedestrian protection airbag device with an airbag that includes a horizontal inflatable portion deployable into a generally rod to cover the lower area of the front windshield and a pair of vertical inflatable portions which extend rearward from opposite ends of the horizontal inflatable portion for covering front surfaces of the front pillars. The airbag includes partition walls that partition the horizontal inflatable portion and vertical inflatable portions, and the horizontal inflatable portion and the vertical inflatable portions communicate with one another through a plurality of small communication holes formed on the partition walls.

JP 2006-69349 A discloses another pedestrian protection airbag device with an airbag that includes a tether inside a horizontal inflatable portion. The tether partitions an interior of the horizontal inflatable portion into front and rear sections and is provided, at the regions in front of vertical inflatable portions, with communication holes for providing gas communication between the front and rear sections.

In the former, an inflation gas discharged from an inflator flows towards left and right ends in the horizontal inflatable portion to inflate the horizontal inflatable portion fully and then the gas flows into the vertical inflatable portions through the communication holes on the partition walls in back- and outward directions. This causes leading ends of the vertical inflatable portions to tilt outwardly and then to bounce back inwardly. This oscillating movement is repeated until the vertical inflatable portions complete inflation. Therefore, this configuration is unsatisfactory in not being able to deploy the vertical inflatable portions over front surfaces of the front pillars quickly.

In the latter, since the communication holes of the tether are located in front of the vertical inflatable portions, an inflation gas flows towards left and right in the front section of the horizontal inflatable portion and then flows into the vertical inflatable portions through the communication holes on the tether in back- and outward directions. Similarly to the former airbag apparatus, this causes the vertical inflatable portions to oscillate in a left and right direction during deployment, and therefore this configuration is likewise unsatisfactory in not being able to deploy the vertical inflatable portions over front surfaces of the front pillars quickly.

### SUMMARY OF THE INVENTION

The object of the present invention is to provide a pedestrian protection airbag device that is capable of deploying vertical inflatable portions located on opposite ends of the horizontal inflatable portion over front surfaces of the front pillars in a quick and steady fashion from an initial stage of airbag deployment.

A pedestrian protection airbag device of the invention is adapted to be mounted on a vehicle and includes:
an airbag housed in a housing that is adapted to be mounted proximate to a rear end of a vehicle hood and proximate to a center of a space between front pillars, the airbag being folded up in front and rear- and left and right directions;
a horizontal inflatable portion of the airbag that is deployable into a generally rod shape extending in a left and right direction over a lower region of a front windshield located at the rear of the vehicle hood;
a pair of vertical inflatable portions of the airbag that extend rearward from opposite ends of the horizontal inflatable portion for covering front surfaces of the front pillars, each of the vertical inflatable portions being folded back toward the horizontal inflatable portion when the airbag is folded up to be housed in the housing;
an inflator that is connected with a front side of the horizontal inflatable portion for feeding an inflation gas to the airbag;
an upper reach region of the horizontal inflatable portion that is located in a front region of the horizontal inflatable portion as inflated, the upper reach region being connected to the inflator and located at an upper reach of a stream of an inflation gas;
a lower reach region of the horizontal inflatable portion that is deployable at the rear of the upper reach region; and
a gas outlet region of the upper reach region that is located at a rear edge of the upper reach region as inflated and inward relative to the vertical inflatable portions in a left and right direction for letting out an inflation gas toward a rear edge of the lower reach region, such that an inflation gas having flown out of the upper reach region via the gas outlet region flows through the lower reach region and then into the vertical inflatable portions.

With the pedestrian protection airbag device of the invention, in an initial stage of airbag inflation, an inflation gas discharged from the inflator will firstly inflate the upper reach region of the horizontal inflatable portion and then flow into the lower reach region through the gas outlet region located on the upper reach region. Then the gas will flow into and inflate the vertical inflatable portions located at left and right ends of the horizontal inflatable portion. The gas outlet region, which serves to let out an inflation gas towards the lower reach region, is located at the rear edge of the upper reach region as inflated and inward relative to the vertical inflatable portions in a left and right direction. Moreover, the gas outlet region is so designed as to feed an inflation gas toward the rear edge of the lower reach region. With this configuration, an inflation gas discharged from the inflator will once fill up the upper reach region and then flow into the lower reach region via the gas outlet region and flow toward the rear edge of the lower reach region. When the gas hits the rear edge of the lower reach region, it will be redirected toward left and right directions, and flow through the lower reach region towards left and right, then flow into the vertical inflatable portions. When the gas reaches the vertical inflatable portions, it will hit left and right outer edges of the vertical inflatable portions, and be redirected again rearward at root regions of the vertical inflatable portions, then flow into the vertical inflatable portions.

That is, the configuration of the pedestrian protection airbag device of the invention will help prevent an inflation gas from flowing into the vertical inflatable portions in back- and outward directions, and let the gas be redirected in stages while the gas flows through the upper reach region and lower reach region before flowing into the vertical inflatable portions. When the gas reaches the vertical inflatable portions, the gas will once bulge the root regions of the vertical inflatable portions with the outward directionality suppressed, and flow through the vertical inflatable portions rearward. Accordingly, the vertical inflatable portions will be prevented from oscillating in a left and right direction during deployment, and deploy over front surfaces of the front pillar in a quick and steady fashion.

Therefore, the airbag device of the invention will be capable of deploying the vertical inflatable portions located on opposite ends of the horizontal inflatable portion over the front surfaces of the front pillars in a quick and steady fashion.

It is desired that the pedestrian protection airbag device of the invention includes inside the horizontal inflatable portion a tether that extends over a generally entire length in a left and right direction of the horizontal inflatable portion and partitions an interior of the horizontal inflatable portion into front and rear such that a region located in front of the tether is the upper reach region whereas a region located at the rear of the tether is the lower reach region, and that a plurality of communication holes are formed on the tether and constitute the gas outlet region.

With this configuration, since the tether is arranged over a generally entire area in a left and right direction inside the horizontal inflatable portion to partition the upper reach region and lower reach region, at full inflation of the airbag, the upper reach region will be deployed over an entire left-right region of the horizontal inflatable portion in an inflated state. When an inflation gas flows into the vertical inflatable portions, accordingly, the upper reach region will reinforce connecting regions between the lower reach region and vertical inflatable portions, since the upper reach region has been already inflated and will work as a rigid body in a shape of a rod including the left and right ends. Further, the communication holes providing communication between the upper reach region and lower reach region are located inward relative to the vertical inflatable portions in a left and right direction. In other words, the upper reach region is so designed as to be closed at the left and right ends. Accordingly, the upper reach region will not lose its rigidity at the left and right ends during inflation of the vertical inflatable portions and securely support the connecting regions between the lower reach region and vertical inflatable portions. This will prevent the vertical inflatable portions from swinging or oscillating in a left and right direction.

In the above airbag device, if the communication holes are provided numerously in such a manner as to form double horizontal lines extending across the region located inward relative to the vertical inflatable portions on the tether, an inflation gas will be redirected easily toward the rear edge of the lower reach region when flowing into the lower reach region from the upper reach region via the communication holes. That is, the gas will be prevented from flowing outwardly in a left and right direction, i.e., directly toward the vertical inflatable portions.

It will also be appreciated that the pedestrian protection airbag device of the invention includes toward a front end of and inside of the horizontal inflatable portion an inner bag that serves as the upper reach region, and that the inner bag includes at a rear edge thereof as inflated a plurality of outlet holes as the gas outlet region.

The outlet holes are also desirably provided numerously in such a manner as to form double horizontal lines extending across a region located inward relative to the vertical inflatable portions at the rear edge of the inner bag. With this configuration, an inflation gas will be easily redirected when the gas flows into the lower reach region from the upper reach region via the outlet holes, i.e., redirected toward the rear edge of the lower reach region. Otherwise the gas would flow outwardly in a left and right direction, i.e., directly toward the vertical inflatable portions.

Further, if the upper reach region is comprised of the inner bag, left and right ends of the inner bag are desirably located inward relative to the vertical inflatable portions in a left and right direction. This configuration will make the inner bag compact in size, and accordingly make the airbag in a folded-up configuration compact so as to be easily housed in the housing.

Moreover, if the upper reach region is comprised of the inner bag, it is desired that the inner bag is so designed as to admit an inflation gas from a generally center in a left and right direction of a front edge thereof as inflated, and that the outlet holes are located generally at a center in a left and right direction of a rear edge of the inner bag as inflated. With this configuration, an inflation gas fed from the inflator will flow into the horizontal inflatable portion, via the inner bag, from the center in a left and right direction of the horizontal inflatable portion, such that the horizontal inflatable portion will start to inflate from the center in a left and right direction. Consequently, the vertical inflatable portions will inflate while the horizontal inflatable portion is sufficiently inflated as a whole from the center to the opposite ends in a left and right direction, which is preferable.

In the pedestrian protection airbag device of the invention, furthermore, if a total opening area of the gas outlet region is generally coincident with a sum of sectional areas of the vertical inflatable portions as fully inflated at vicinities of connecting regions with the horizontal inflatable portion, the vertical inflatable portions will inflate quickly although an inflation gas makes a detour through the lower reach region before flowing into the vertical inflatable portions. Further, the upper reach region will be prevented from undue increase in internal pressure.

It will also be appreciated with the pedestrian protection airbag device of the invention, that the airbag includes a lower wall deployable at a lower side and an upper wall deployable at an upper side, the airbag further includes in an area of the horizontal inflatable portion a plurality of partitioning portions that are formed intermittently by joining the lower wall and the upper wall so as to extend in a left and right direction and partition the upper reach region and the lower each region, and that the gas outlet region is comprised of clearances formed between the portioning portions.

It will further be appreciated with the above pedestrian protection airbag device that the airbag as housed in the housing is folded up, from a flattened state where the upper wall and the lower wall overlap with each other, through a front-rear contraction step which reduces a width of the airbag in a front and rear direction, and a left-right contraction step which reduces a width of the airbag in a left and right direction; in the front-rear contraction step, at least the vertical inflatable portions are rolled on the lower wall from rear ends thereof; and in the left-right contraction step, left and right ends of a front-rear contracted bag, which has gone through the front-rear contraction step, are brought close to a center in a left and right direction of the airbag such that the vertical inflatable portions are folded back on the horizontal inflatable portion.

With this configuration, when fed with an inflation gas upon deployment, the airbag will firstly unfurl in such a manner as to undo the folds formed in the left-right contraction step, and then unfurl and inflate in such a manner as to undo the folds made in the front-rear contraction step. Since the vertical inflatable portions are folded back toward the horizontal inflatable portion in the left-right contraction step, the vertical inflatable portions will unfurl quickly towards left and right when the upper reach region is fed with an inflation gas in an initial stage of airbag inflation. Further, since the vertical inflatable portions are rolled on the lower wall from the rear ends, they will roll out along front surfaces of the front pillars upon deployment, rather than oscillating or floating up from the front pillars while unfurling. Consequently, the vertical inflatable portions will deploy quickly over the front pillars.

### BRIEF DESCRIPTION OF DRAWINGS

FIG. 1 is a plan view of a vehicle provided with a pedestrian protection airbag device according to the first embodiment of the invention;

FIG. 2 is a partial enlarged plan view of a right rear end region of a hood of the vehicle of FIG. 1;

FIG. 3 is a schematic vertical section of the vehicle of FIG. 1 taken along line III-III of FIG. 2, showing an actuator;

FIG. 4 is a schematic vertical section of the airbag device of the first embodiment, taken along line IV-IV of FIG. 1;

FIG. 5 is a schematic vertical section of the airbag device of the first embodiment, taken along line V-V of FIG. 1;

FIG. 6 is a plan view of an airbag of the airbag device of the first embodiment as is flattened;

FIG. 7 is a sectional view of the airbag of FIG. 6 as is inflated by itself, taken along line VII-VII of FIG. 6;

FIG. 8 is a sectional view of the airbag of FIG. 6 as is inflated by itself, taken along line VIII-VIII of FIG. 6;

FIG. 9 shows base members of the airbag of FIG. 6 by plan views;

FIGS. 10A to 10D schematically depict the folding process of the airbag of FIG. 6;

FIG. 11 is a schematic vertical section of the vehicle of FIG. 1 showing the actuator in service;

FIG. 12 is a vertical section of the airbag device of the first embodiment as the airbag is fully inflated;

FIG. 13 is a partial enlarged plan view of the airbag device of the first embodiment as the airbag is fully deployed;

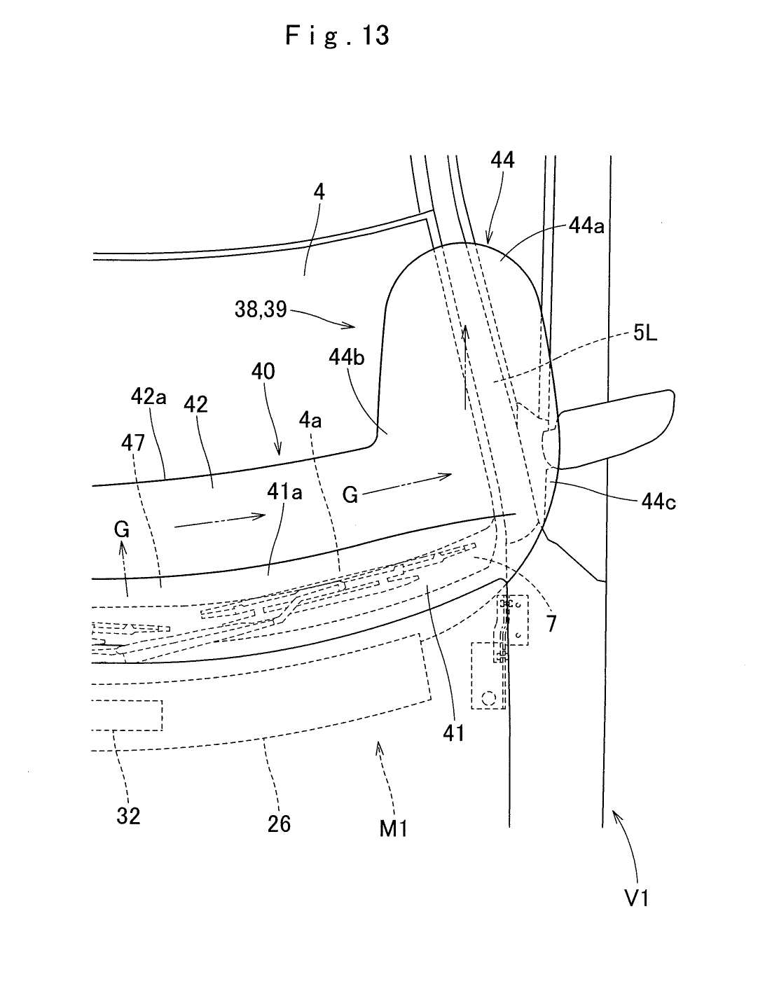

FIG. 14 is a plan view of a vehicle provided with a pedestrian protection airbag device according to the second embodiment of the invention;

FIG. 15 is a schematic vertical section of the airbag device of the second embodiment, taken along line XV-XV of FIG. 14;

FIG. 16 is a plan view of an airbag of the airbag device of the second embodiment as is flattened;

FIG. 17 is a sectional view of the airbag of FIG. 16 as is inflated by itself, taken along line XVII-XVII of FIG. 16;

FIG. 18 is a sectional view of the airbag of FIG. 16 as is inflated by itself, taken along line XVIII-XVIII of FIG. 16;

FIG. 19 is a plan view of an inner bag for use in the airbag of FIG. 16;

FIG. 20 shows base members of the airbag of FIG. 16 by plan views;

FIGS. 21A to 21D schematically depict the folding process of the airbag of FIG. 16;

FIG. 22 is a vertical section of the airbag device of the second embodiment as the airbag is fully inflated;

FIG. 23 is a partial enlarged plan view of the airbag device of the second embodiment as the airbag is fully deployed;

FIG. 24 is a plan view of a modification of the airbag for use in the second embodiment as is flattened;

FIG. 25 is a sectional view of the airbag of FIG. 24 as is inflated by itself, taken along line XXV-XXV of FIG. 24;

FIG. 26 shows base members of the airbag of FIG. 24 by plan views;

FIG. 27 is a plan view of a vehicle provided with a pedestrian protection airbag device according to the third embodiment of the invention;

FIG. 28 is a schematic vertical section of the airbag device of the third embodiment, taken along line XXVIII-XXVIII of FIG. 27;

FIG. 29 is a schematic vertical section of the airbag device of the third embodiment, taken along line XXIX-XXIX of FIG. 27;

FIG. 30 is a plan view of an airbag for use in the third embodiment as is flattened;

FIG. 31 is a bottom view of the airbag of FIG. 30;

FIG. 32 is a sectional view of the airbag of FIG. 30 as is inflated by itself, taken along line XXXII-XXXII of FIG. 30;

FIG. 33 is a sectional view of the airbag of FIG. 30 as is inflated by itself, taken along line XXXIII-XXXIII of FIG. 30;

FIG. 34 shows base members of the airbag of FIG. 30 by plan views;

FIGS. 35A, 35B and 36A to 36C schematically depict the folding process of the airbag of FIG. 30;

FIG. 37 is a vertical section of the airbag device of the third embodiment as the airbag is fully inflated; and

FIG. 38 is a partial enlarged plan view of the airbag device of the third embodiment as the airbag is fully deployed.

### DESCRIPTION OF PREFERRED EMBODIMENTS

Preferred embodiments of the present invention are described below with reference to the accompanying drawings. However, the invention is not limited to the embodiments disclosed herein. All modifications within the appended claims and equivalents relative thereto are intended to be encompassed in the scope of the claims.

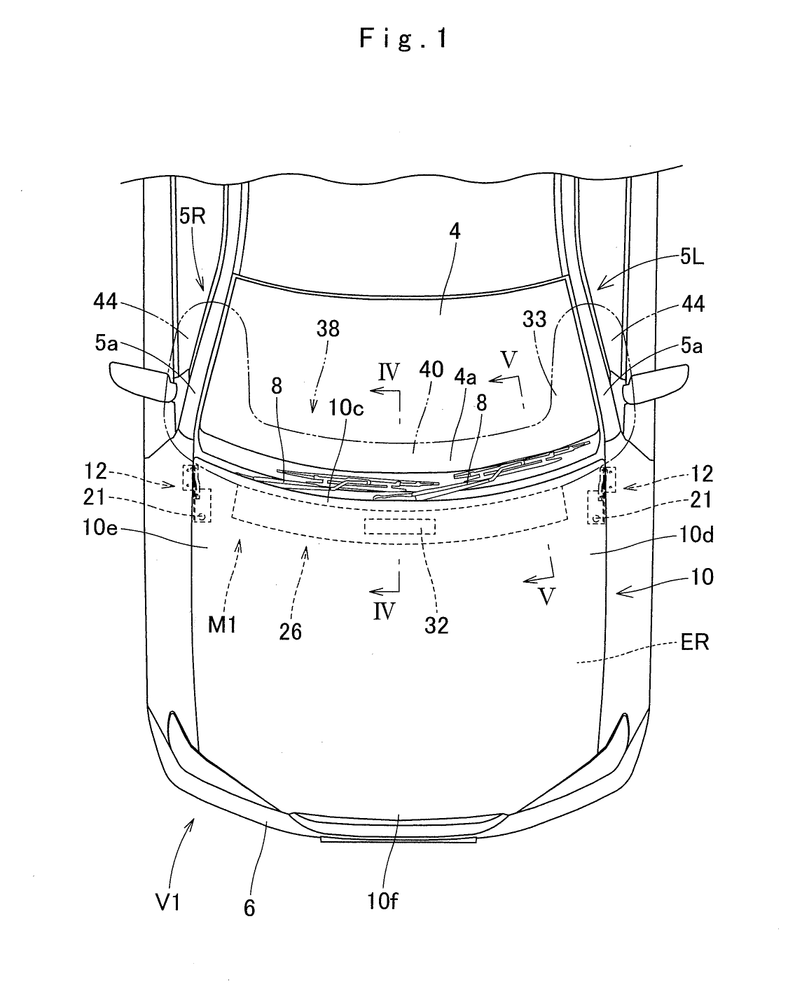

As shown in FIG. 1, a pedestrian protection airbag device M1 according to the first embodiment of the present invention is located at a vicinity of the center in a left and right direction of a vehicle V1, between the left and right front pillars 5L and 5R, at the rear end 10c of the vehicle hood 10. Unless otherwise specified, front/rear, up/down and left/right directions in this specification are intended to refer to front/rear, up/down and left/right directions of the vehicle V1.

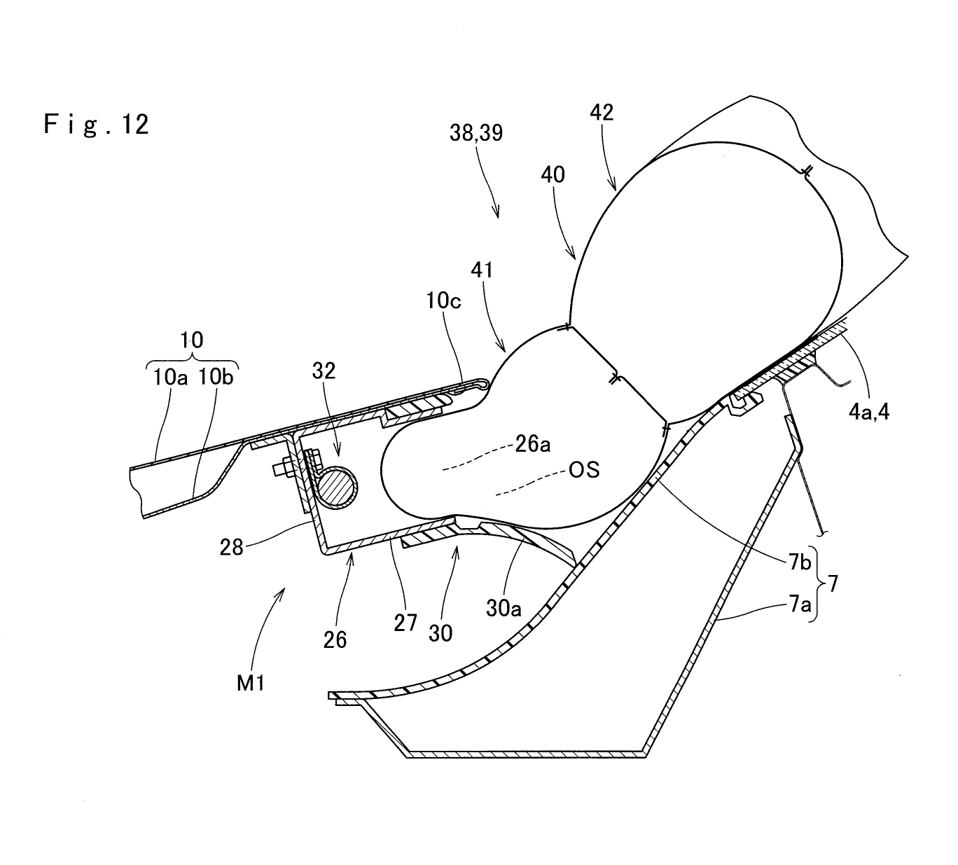

The vehicle V1 includes inside the front bumper 6 (FIG. 1) an unillustrated sensor that detects an impact against a pedestrian. An unillustrated actuating circuit is designed to activate an inflator 32 of the airbag device M1 in response to a signal fed from the sensor that has sensed an impact against a pedestrian. The vehicle V1 further includes beneath the left edge 10d and right edge 10e at a vicinity of the rear end 10c of the hood 1 actuators 21 for lifting the rear end 10c of the hood 10. The actuators 21 are designed to be actuated generally simultaneously with the inflator 32 to lift the rear end 10c of the hood 10 in order that a clearance OS is formed between the rear end 10c of the hood 10 and the cowl 7 (FIG. 12), from which clearance an airbag is to emerge.

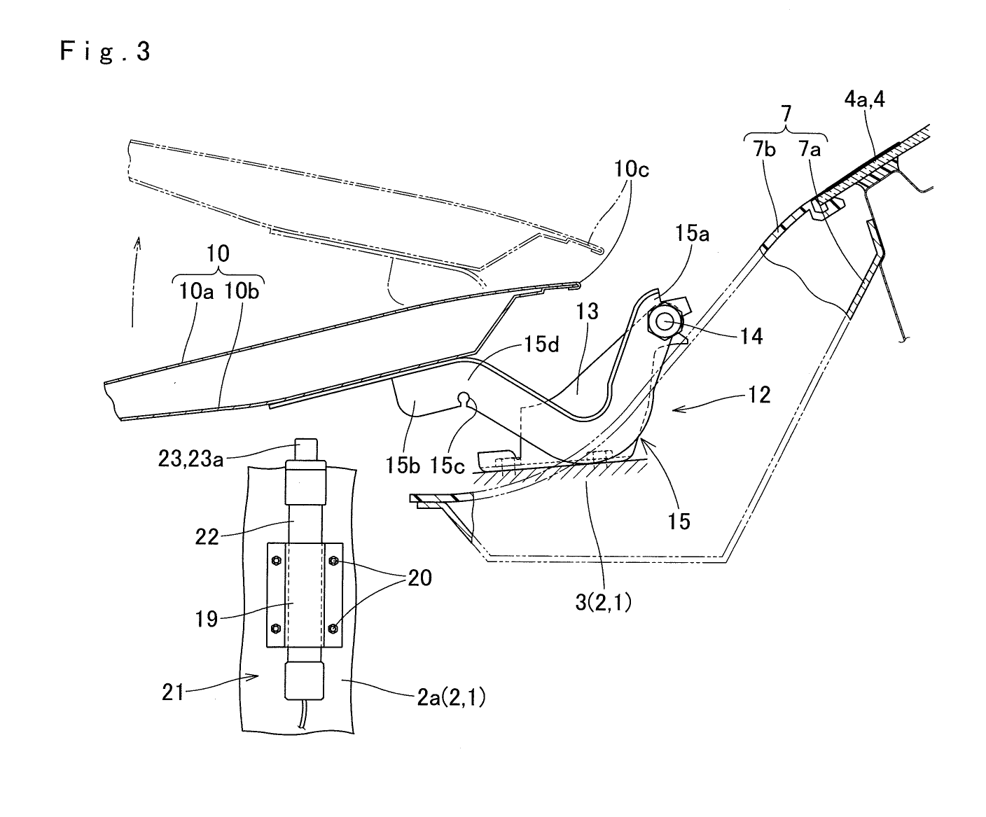

As shown in FIG. 1, the hood panel 10 covers an engine room ER of the vehicle V1 and is joined to the body structure 1 of the vehicle V1 with hinge mechanisms 12 located at left and right edges of the rear end so as to be openable forward. The vehicle hood 10 of the embodiment is fabricated of plate material of aluminum (aluminum alloy) or the like, and is comprised of an outer panel 10a, which forms the top face, and an inner panel 10b, which forms the lower face and is greater in strength than the outer panel 10a, as shown in FIGS. 3 to 5. As shown in FIG. 1, in order to fit the later-described front windshield 4, the rear end 10c of the hood panel 10 is so designed in shape as to curve relative to a left and right direction such that the center in a left and right direction is located forward whereas left and right end regions are located rearward.

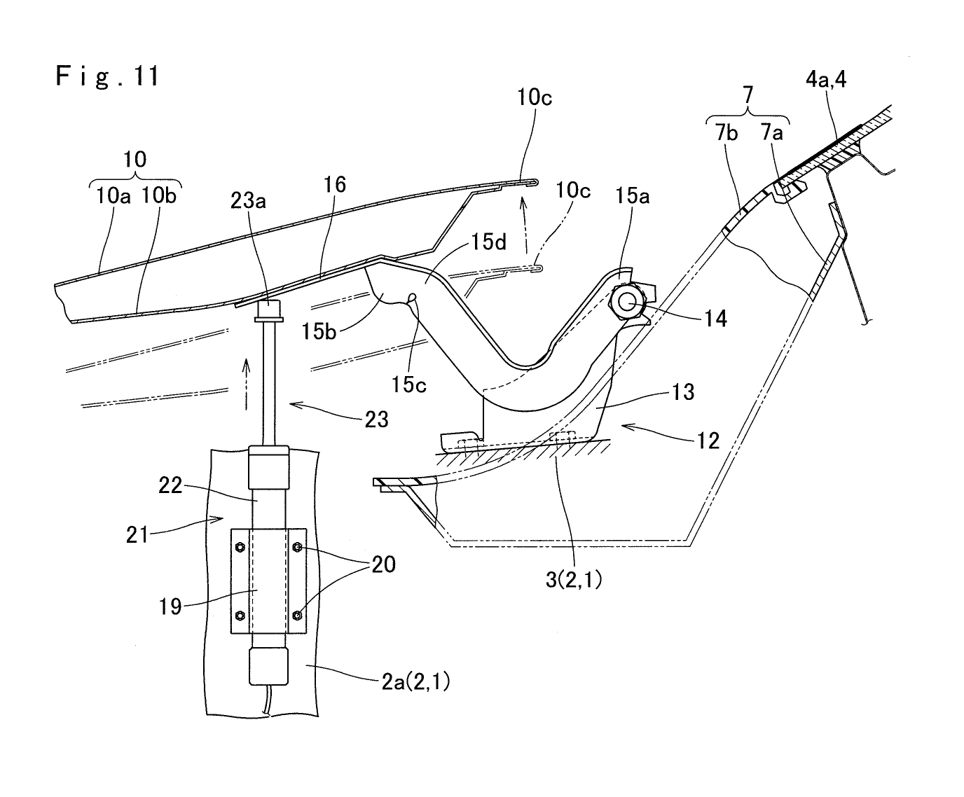

As shown in FIGS. 3 to 5, at the rear of the hood 10 is a cowl 7 that is comprised of a cowl panel 7a, which has high rigidity, and a cowl louver 7b located above the cowl panel 7a and is fabricated of synthetic resin. The cowl louver 7b is continuous at the rear end with the lower region 4a of the front windshield 4. The cowl 7 is also shaped along the curvature of the rear end 10c of the hood 10 to curve relative to a left and right direction such that the center in a left and right direction is located forward whereas left and right end regions are located rearward. As shown in FIG. 1, a pair of wipers 8 is provided on the cowl 7. The wipers 8 are so provided as to protrude upward from the cowl louver 7b, although not depicted in the drawings. Front pillars 5L and 5R are located on the left and right of the front windshield 4. In this embodiment, the lower edge of the front windshield 4 is so designed in shape as to curve relative to a left and right direction such that the center in a left and right direction is located forward whereas left and right end regions are located rearward. Although the hood 10 is pushed up at the rear end 10c as shown in FIG. 11 when the actuator 21 is actuated, the hood 10 is not disengaged from the vehicle body structure 1 since the front end 10f of the hood 10 is retained by an unillustrated hood lock mechanism in which a latch holds a striker.

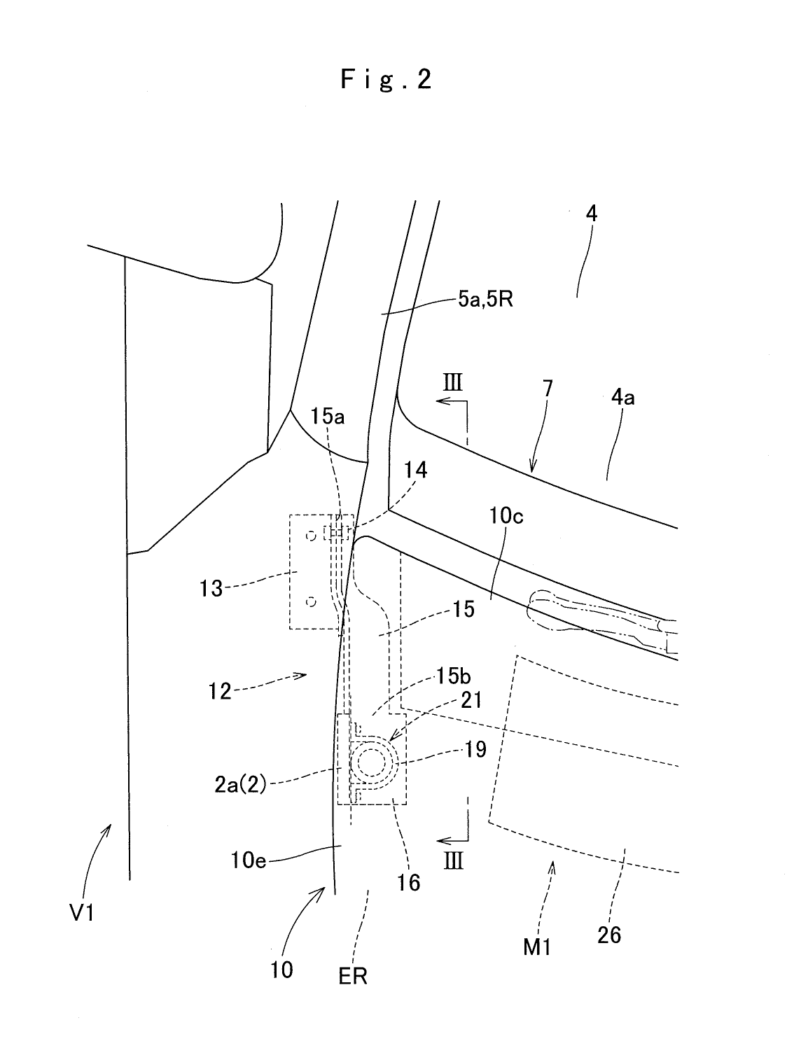

The hinge mechanisms 12 are located at the left edge 10d and right edge 10e of the rear end 10c of the vehicle hood 10 (FIGS. 1 and 2), and are respectively provided with a hinge base 13 and a hinge arm 15 secured to the vehicle hood 10, as shown in FIGS. 2 and 3. Each of the hinge bases 13 is secured to a mounting flange 3 mounted on a hood ridge reinforcement 2, which is a part of the vehicle body structure 1. As shown in FIG. 3, each of the hinge arms 15 is formed of an angle material of sheet metal shaped into a generally semicircular arc protruding downwardly. The root end 15a of the hinge arm 15 is rotatably joined to the hinge base 13 with a support shaft 14. As shown in FIGS. 2 and 3, each of the hinge arms 15 includes on the leading end 15b facing away from the root end 15a a joint plate 16 which extends from the leading end 15b generally along the underside of the vehicle hood 10. The joint plate 16 is connected to the underside of the rear end 10c of the vehicle hood 10 by welding or the like. As shown in FIG. 3, a generally round cavity 15c is formed on the lower edge in a vicinity of the leading end 15b of the hinge arm 15. The region around the cavity 15c serves as a plastic deformation portion 15d that is plastically deformable for allowing the rise of the rear end 10c of the hood 10 when piston rods 23b of the actuators 21 push up the rear end 10c of the hood 10 (FIG. 11). As shown in FIGS. 2 and 3, the support shafts 14 are so arranged that the axial direction extends along a left and right direction of the vehicle V1. As indicated by double-dotted lines in FIG. 3, the vehicle hood 10 opens forward around the support shafts 14 by lifting the front end 10f (FIG. 1) of the hood 10. The actuators 21 are located on the left and right of the airbag device M1 (or the case 26) as shown in FIGS. 1 and 2. More specifically, as shown in FIG. 2, the actuators 21 are located beneath the hinge mechanisms 12, which are provided beneath the left edge 10d and right edge 10e of the rear end 10c of the hood 10. As shown in FIG. 3, each one mounting bracket 19, which has a generally U-shaped section, is bolt 20 secured to a mounting flange 2a secured to the hood ridge reinforcement 2, and each of the actuators 21 is held by the mounting bracket 19. Each of the actuators 21 includes a gas generator (unillustrated) as the driving force, a cylinder 22 and a piston rod 23 stored inside the cylinder 22 and projecting upward from the cylinder 22. The gas generator is stored at the bottom of the cylinder 22. The actuator 21 is so designed as to launch a piston (unillustrated) of the piston rod 23 with a gas that the gas generator emits. If the actuator 21 is actuated, the top 23a of the piston rod 23 abuts against the underside of the joint plate 16 attached to the leading end 15b of the hinge arm 15 located on the underside of the rear end 10c of the hood 10. That is, the top 23a of the piston rod 23 lifts the rear end 10c of the hood 10 as shown in FIG. 11, thereby forming a clearance OS between the cowl 7 and the rear end 10c of the hood 10, such that an airbag 38 is allowed to emerge (FIG. 12).

Referring to FIGS. 1, 4 and 5, the airbag device M1 includes an airbag 38, an inflator 32 that feeds an inflation gas to the airbag 38, a case or housing 26 that houses the airbag 38 and inflator 32, and an airbag cover 30 that covers the airbag 38 in a folded-up configuration.

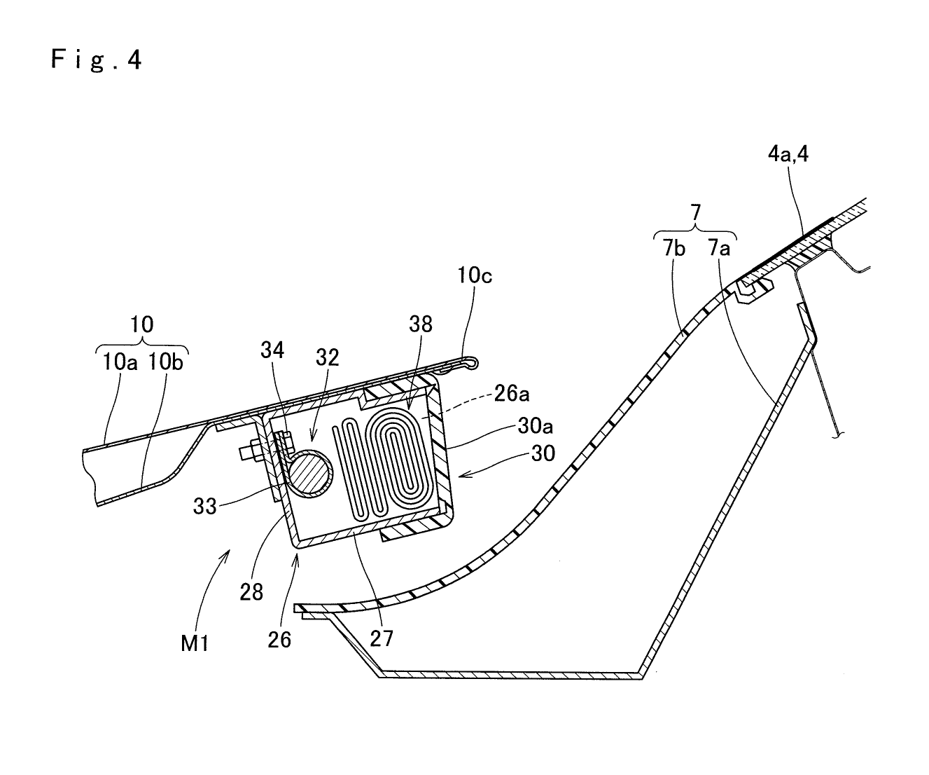

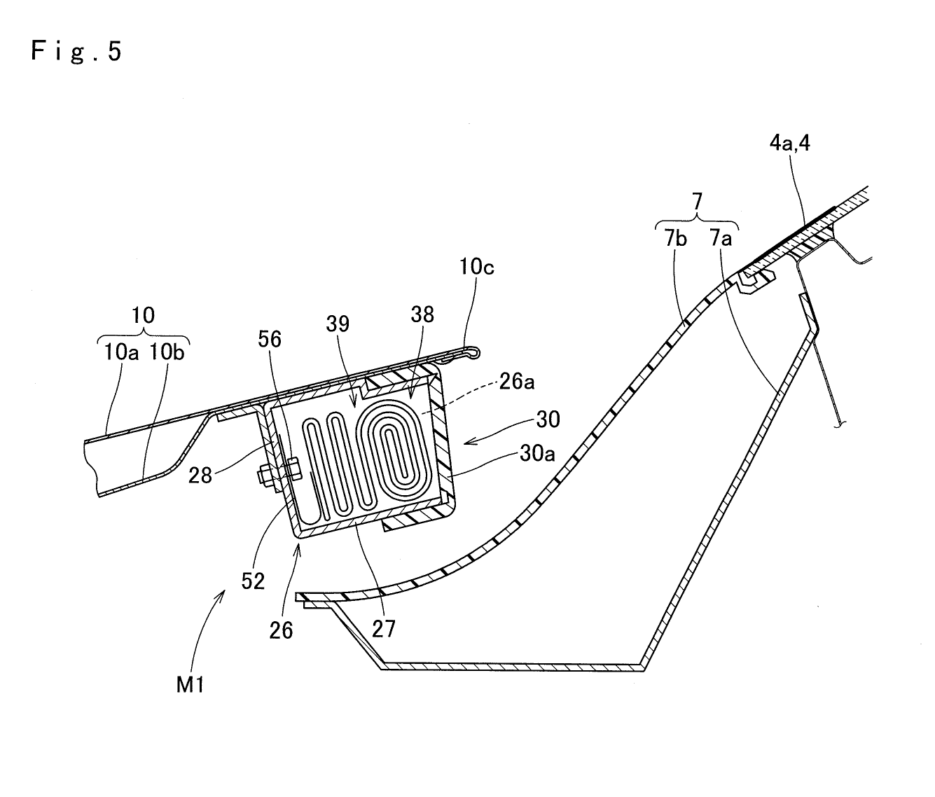

The case or housing 26 is made of a sheet metal and formed into a generally box shape provided with a generally square tubular circumferential wall 27 opening rearward and a bottom wall 28 closing the front end of the circumferential wall 27, as shown in FIGS. 4 and 5. The airbag 38 emerges from an emergence opening 26a formed at the rear end of the case 26 upon deployment. In this specific embodiment, the case 26 is directly joined to the underside of the hood 10 by a bracket (reference numeral omitted) at the rear end 10c of the hood 10. The case 26 is elongated in a left and right direction in shape and located at the center in a left and right direction between the front pillars 5L and 5R. As shown in FIG. 1, in the illustrated embodiment, the case 26 is so designed in shape as to curve relative to a left and right direction along the curvature of the rear end 10c of the hood 10 such that the center in a left and right direction is located forward whereas left and right end regions are located rearward. More specifically, the left and right ends of the case 26 are located proximate to the lower regions of the front pillars 5L and 5R, as shown in FIGS. 1 and 2.

As shown in FIGS. 4 and 5, the airbag cover 30 is fabricated of synthetic resin and covers the emergence opening 26a of the case 26 as shown in FIGS. 4 and 5. The airbag cover 30 includes a door 30a which is openable when pushed by the airbag 38 upon deployment.

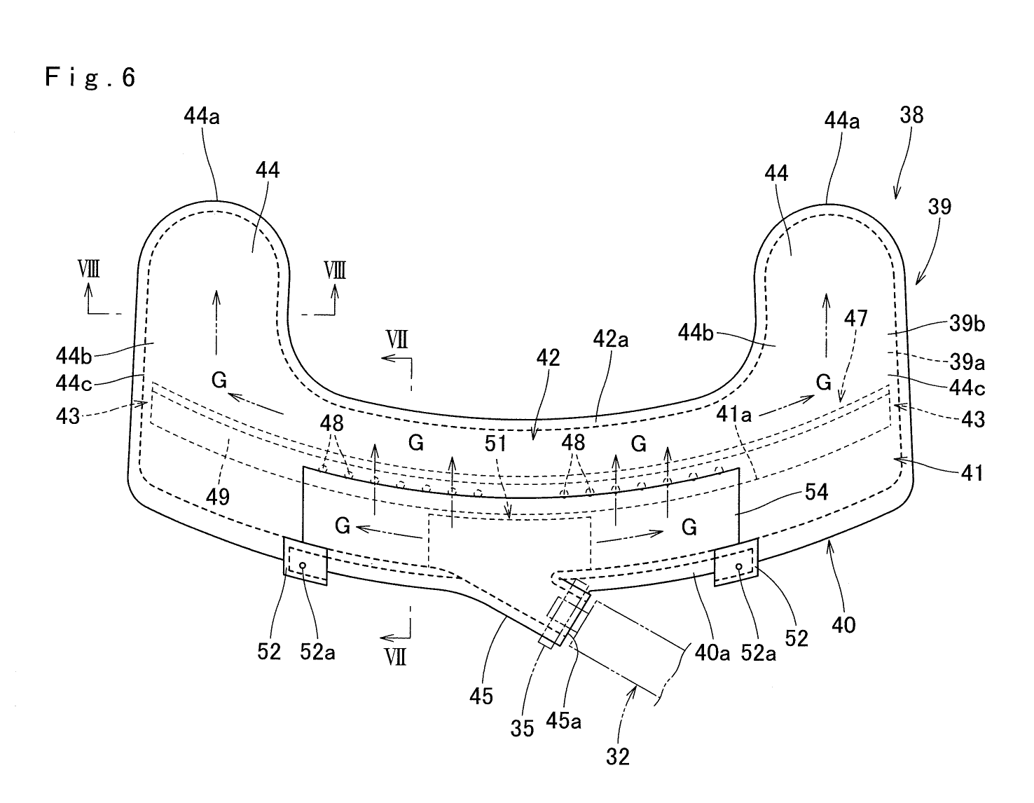

As shown in FIGS. 1 and 4, the inflator 32 is generally cylindrical in shape and so arranged that the axial direction extends along a left and right direction. The inflator 32 is provided at a first end in a left and right direction (at the right end, in the illustrated embodiment) gas discharge ports (unillustrated) for discharging an inflation gas, and is electrically connected to an actuation circuit through a lead wire (unillustrated). As shown in FIG. 4, the inflator 32 is secured to the bottom wall 28 of the case 26 by a retainer 33 that is mounted around the inflator 32 and is bolt 34 fixed to the bottom wall 28. The inflator 32 is joined at the right end with the gas discharge ports to a later-described gas inlet port 45 of the airbag 38 by a clamp 35, as indicated by double-dotted lines in FIG. 6.

Referring to FIGS. 6 to 8, the airbag 38 includes a bag body 39 inflatable with an inflation gas, a tether 47 located inside a later-described horizontal inflatable portion 40 of the bag body 39, a pair of mounting portions 52 serving to mount the bag body 39 on the case 26, and an inner tube 51 located inside the bag body 39.

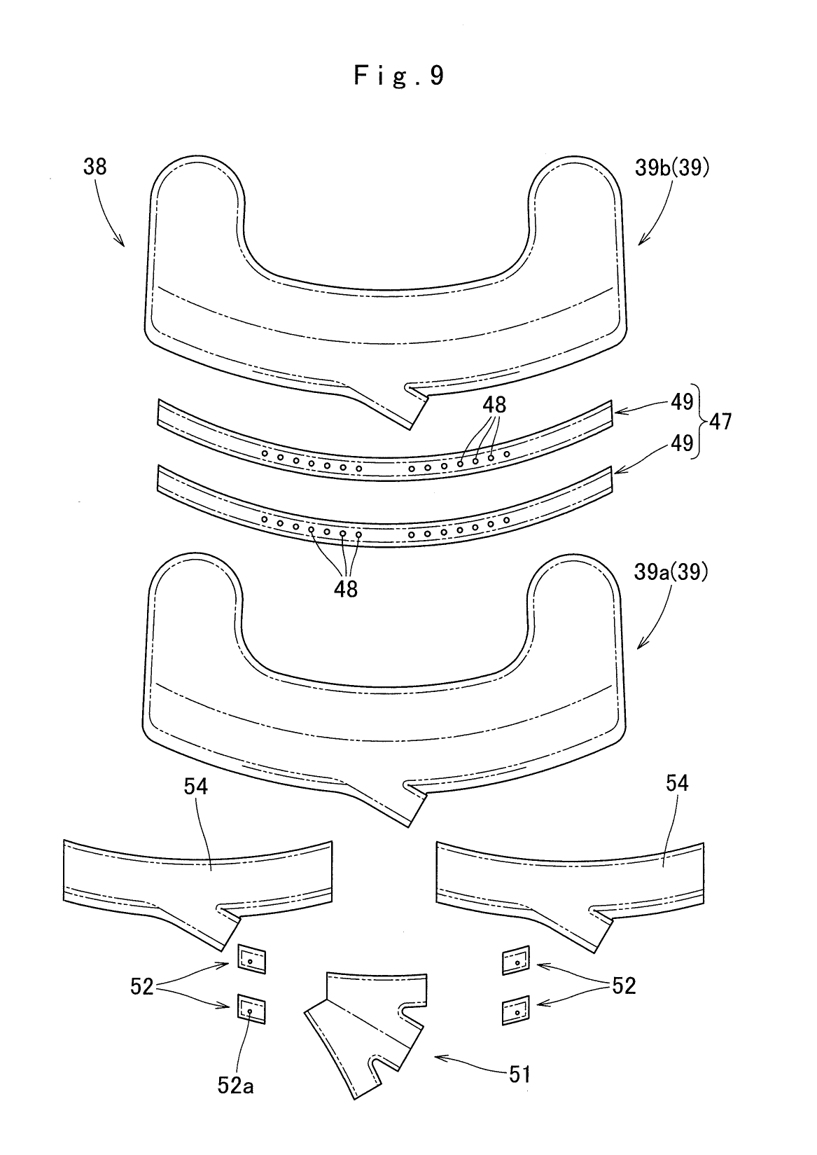

As shown in FIGS. 1 and 6, the bag body 39 is inflatable into a generally U shape elongated in a left and right direction as viewed from the front. The bag body 39 includes a horizontal inflatable portion 40 that extends in a left and right direction along the lower region 4a of the front windshield 4 upon deployment, a pair of vertical inflatable portions 44 that extend rearward from opposite ends of the horizontal inflatable portion 40 and cover the front surfaces of the front pillars 5L and 5R, and a gas inlet port 45 that protrudes from a generally center in a left and right direction of the front edge 40a of the horizontal inflatable portion 40 and is connected with the inflator 32. In the illustrated embodiment, as shown in FIG. 9, the bag body 39 is formed of a lower wall 39a deployable at the lower side and an upper wall 39b deployable at the upper side, which walls 39a and 39b are generally identical in outer contour and are sewn (joined) together by the circumferential edges with sewing threads except at the leading end 45a of the gas inlet port 45.

More specifically, the horizontal inflatable portion 40 is designed to cover the upper surface of an area ranging from the cowl 7 to the lower region 4a of the front windshield 4 including the wipers 8, and is inflatable into a rod shape curving relative to a left and right direction, along the curvature of the rear end 10c of the hood 10, such that the center in a left and right direction is located forward whereas left and right end regions located rearward. Even more specifically, the horizontal inflatable portion 40 is so designed that its front edge region (or the front edge region of an upper reach region 41) is deployable beneath the rear end 10c of the hood 10 (FIG. 12). In the illustrated embodiment, the horizontal inflatable portion 40 internally includes a tether 47 that extends over an entire region of the horizontal inflatable portion 40 in a left and right direction and partitions the horizontal inflatable portion 40 into front and rear. The region located in front of the tether 47 and enclosed by the tether 47, the lower wall 39a and the upper wall 39b is an upper reach region 41, which is located at the upper reach of a stream of an inflation gas G discharged from the inflator 32, whereas the region located at the rear of the tether 47 and enclosed by the tether 47, the lower wall 39a and the upper wall 39b is a lower reach region 42, which is located at the rear of the upper reach region 41. As described later, the tether 47 is arranged in such a manner as to curve generally along the curvature of the horizontal inflatable portion 40, generally at the center in a front and rear direction of the horizontal inflatable portion 40. The upper reach region 41 and the lower reach region 42 respectively extend over an entire area in a left and right direction, and widths in a front and rear direction of the upper reach region 41 and lower reach region 42 are generally identical over an entire area in a left and right direction.

The vertical inflatable portions 44 are deployable over the front surfaces of the front pillars 5L and 5R. The width in a left and right direction of each of the vertical inflatable portions 44 in a flattened state is slightly smaller than the width in a front and rear direction of the horizontal inflatable portion 40 in a flattened state. More specifically, each of the vertical inflatable portions 44 is so sized in length as to cover generally entire front surfaces of the front pillars 5L and 5R.

The gas inlet port 45 protrudes forward from the front edge 40a of the horizontal inflatable portion 40. The leading end 45a of the gas inlet port 45 is open so as to be connected to the inflator 32. In other words, the gas inlet port 45 of the airbag 38, which is to be connected to the inflator 32, is provided in such a manner as to extend from the front edge of the upper reach region 41, which is a front section, away from the rear edge, of the horizontal inflatable portion 40. Accordingly, an inflation gas discharged from the inflator 32 firstly flows into the upper reach region 41 of the horizontal inflatable portion 40 through the gas inlet port 45. More specifically, the gas inlet port 45 is formed into a generally tubular shape extending in a slanted fashion relative to a front and rear direction, such that the leading end 45a is directed toward left, and its root region is in gas communication with the horizontal inflatable portion 40 at the generally center in a left and right direction of the upper reach region 41. The airbag 38 of the illustrated embodiment is provided internally with an inner tube 51 (FIG. 6), which is separate from the bag body 39, in order to protect the gas inlet port 45 and a region of the upper reach region 41 proximate to the gas inlet port 45. The inner tube 51 includes a region for covering the inner surface of the gas inlet port 45 and a region to be located at and to cover the center in a left and right direction of the upper reach region 41. These two regions communicate each other and the region located inside of the upper reach region 41 is formed into a generally tube which are open at left and right ends.

The tether 47 is formed into a generally band, and is so located at the generally center in a front and rear direction inside of the horizontal inflatable region 40 as to extend continuously over a generally entire region in a left and right direction of the horizontal inflatable region 40. The upper edge and lower edge of the tether 47 are sewn and connected to the upper wall 39b and lower wall 39a of the bag body 39, respectively, with sewing threads. The tether 47 serves to restrain a thickness of the horizontal inflatable portion 40 as fully inflated such that the horizontal inflatable region 40 covers a wide area in a front and rear direction from the cowl 7 to the lower area 4a of the front windshield 4. The tether 7 also serves to partition an interior of the horizontal inflatable region 40 into the upper reach region 41 and the lower reach region 42, and defines the rear edge 41a of the upper reach region 41. More specifically, as shown in FIG. 6, the tether 47 is so arranged inside the horizontal inflatable portion 40, curving along with the horizontal inflatable region 40, that the center in a left and right direction is located forward whereas left and right end regions located rearward, and that small gaps 43 are formed between the tether 47 and left and right edges of the horizontal inflatable region 40. The gaps 43 serve to vent an extra inflation gas which has flown into the upper reach region 41 of the horizontal inflatable region 40, and are so sized as not to hinder the horizontal inflatable portion 40 from supporting the vertical inflatable portions 44 in an initial stage of airbag deployment. In the illustrated embodiment, the tether 47 is divided into two, upper and lower sections, and is comprised of two pieces of tether cloths 49, as shown in FIG. 9.

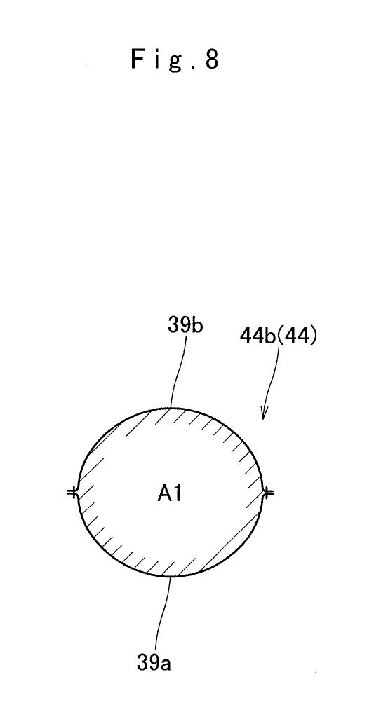

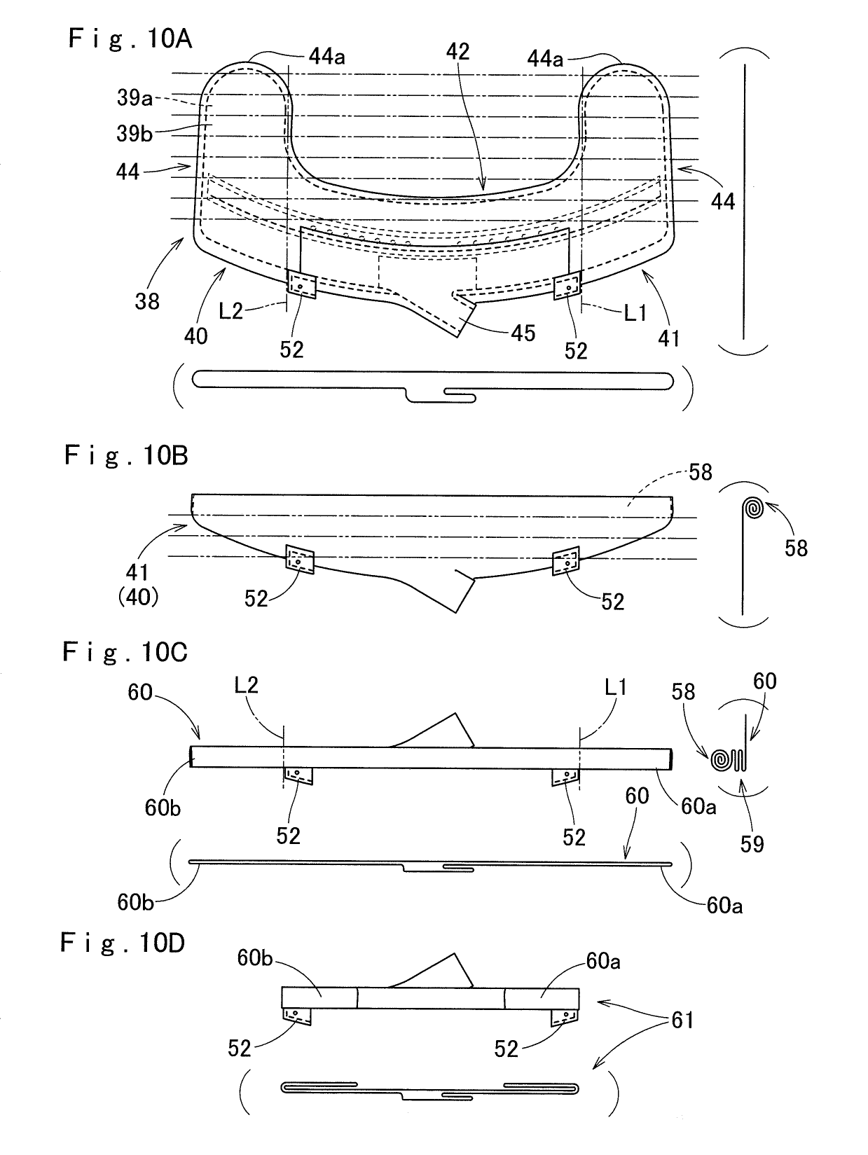

The tether 47 includes at the region inward relative to the vertical inflatable portions 44 in a left and right direction at full deployment of the bag body 39 a plurality of communication holes 48 that provide communication between the upper reach region 41 and lower reach region 42. The communication holes 48 constitute a gas outlet region that is located at the rear edge 41a of the upper reach region 41 as inflated and serves to let out an inflation gas G toward the rear edge 42a of the lower reach region 42. In the illustrated embodiment, the communication holes 48 are formed at the region located inward relative to later-described creases L1 and L2 (FIG. 10C) in a left and right direction and not a vicinity of the center in a left and right direction of the tether 47 where the inner tube 51 is located. The creases L1 and L2 are formed on the bag body 39 when the bag body 39 is reduced in size in a left and right direction to fit in the case 26 by folding. More specifically, as shown in FIG. 9, there are formed twenty-eight communication holes 48 in total; each 7 holes are located on the left side and right side of each of the tether cloths 49. Each of the communication holes 48 is generally round. The total opening area of the communication holes 48 (i.e., of the gas outlet region) is generally coincident with the sum (A1×2) of sectional areas A1 (FIG. 8) of the vertical inflatable portions 44 as fully inflated at a vicinity of connecting regions with the horizontal inflatable portion 40 (i.e., sectional areas at the root regions 44b of the vertical inflatable portions 44). In the illustrated embodiment, out of the communication holes 48, each two innermost holes overlap in position in a front and rear direction with the inner tube 51.

The mounting portions 52 are used to mount the bag body 39 on the case 26. The mounting portions 52 extend forward from the front edge 40a of the horizontal inflatable portion 40. In the illustrated embodiment, two mounting portions 52 are provided on the left and right of the gas inlet port 45. Each of the mounting portions 52 is provided with an insert hole 52a for receiving a bolt 56, which is used to fix the mounting portion 52 on the bottom wall 28 of the case 26, as shown in FIG. 5. More specifically, each of the mounting portions 52 is positioned inward relative to the vertical inflatable portion 44 in a left and right direction and is so positioned as to be located proximate to left and right ends of the bottom wall 28 of the case 26 when it is stored therein. When the bag body 39 is folded on the above-described creases L1 and L2 (FIG. 10C) and reduced in width in a left and right direction, the creases L1 and L2 are formed outward of the communication holes 48 and outward of the mounting portions 52 in a left and right direction.

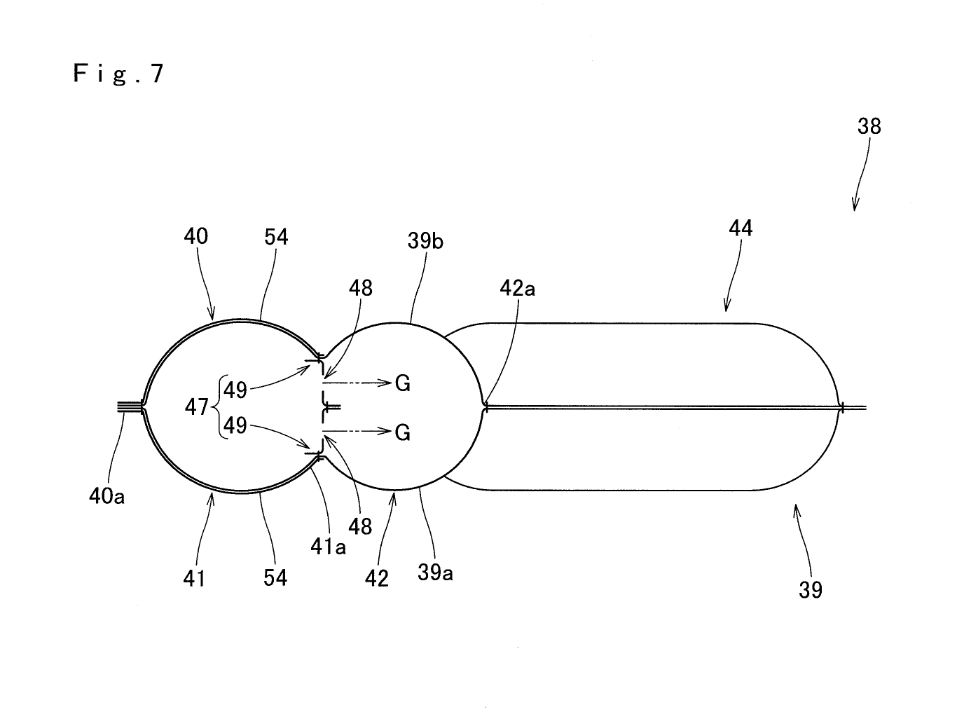

The bag body 39 of the illustrated embodiment is further provided, on the central region in a left and right direction of the upper reach region 41 of the horizontal inflatable portion 40, with reinforcing cloths 54. As shown in FIGS. 6 and 7, the reinforcing cloths 54 are arranged over the outer circumferences of the upper wall 39b and lower wall 39a, respectively, in such a manner as to overlap with the upper wall 39b and lower wall 39a. More specifically, the reinforcing cloths 54 cover the upper and lower surfaces of the upper reach region 41 and gas inlet port 45 at a region between the mounting portions 52. The reinforcing cloths 54 are sewn to the upper wall 39b and lower wall 39a by the front and rear edges together with the stitches to form the outer circumferential edge of the bag body 39 and with the stitches to sew the upper and lower edges of the tether 47 to the upper wall 39a and lower wall 39a.

In the illustrated embodiment, the bag body 39, tether 47, inner tube 51, mounting portions 52 and reinforcing cloths 54 are made of a fabric woven of polyester yarn, polyamide yarn or the like and coated with a coating agent for preventing gas leakage.

The mounting of the airbag device M1 of the first embodiment on a vehicle V1 is now described. Firstly, the airbag 38 is folded up for storage in the case 26. As shown in FIGS. 10A to 10D, in this embodiment, the airbag 38, so flattened that the upper wall 39b and lower wall 39a overlap with each other, is folded up through the front-rear contraction step, which reduces the width in a front and rear direction, and the left-right contraction step, which reduces the width in a left and right direction. The front-rear contraction step consists of two sub-steps: as shown in FIG. 10A, a rear half region of the flattened airbag 38 (more precisely, the region located rearward relative to the center in a front and rear direction of the central area in a left and right direction of the lower reach region 42 of the horizontal inflatable portion 40) is rolled on the lower wall 39a from the leading ends or rear ends 44a of the vertical inflatable portions 44, thereby forming a rolled portion 58, as shown in FIG. 10B. Then a remaining front half region is folded in a bellows fashion on creases extending along a left and right direction, thereby forming a bellows-folded portion 59, as shown in FIG. 10C. Thus the front-rear contraction step is completed. The airbag in this state is referred to as a front-rear contracted bag 60. The left-right contraction step is conducted by folding the front-rear contracted bag 60 on creases L1 and L2 extending along a front and rear direction, as shown in FIG. 10C, at the positions located inward of the vertical inflatable portions 44 in a left and right direction, i.e., proximate to the immediate outside of the connecting portions 52 in a left and right direction, such that the left and right ends 60a and 60b of the front-rear contracted bag 60 are brought towards and directed to the center in a left and right direction. That is, the whole vertical inflatable portions 44 are folded back on the horizontal inflatable portion 40, thus the left-right contraction step is completed as shown in FIG. 10D and a completely-folded body 61, which fits in the case 26, is provided. On the completely-folded body 61, the communication holes 48 of the tether 47 are arranged over a generally entire region in a left and right direction except the regions folded back in the left-right contraction step.

The completely-folded body 61 is wrapped up by a tearable wrapping member (unillustrated) for keeping the folded-up configuration. At this time, the leading end 45a of the gas inlet port 45 and mounting portions 52 are taken out of the wrapping member. Then the leading end 45a of the gas inlet port 45 is connected with the inflator 32 with a clamp 35, and bolts 56 are inserted through the inset holes 52a of the mounting portions 52. Subsequently, the inflator 32 held by the retainer 33 and airbag 38 are set in the case 26 such that the bolts 56 and bolts 34 of the retainer 33 project out of the bottom wall 28 of the case 26, and the bolts 34 and 56 are fastened with nuts (reference numeral omitted). Thus the airbag 38 and inflator 32 are stored in and fixed to the case 26.

Thereafter, the airbag cover 30 is attached to the case 26 and the case 26 is mounted on the vehicle hood 10 with brackets (reference numeral omitted). If then the inflator 32 is electrically connected to an unillustrated actuation circuit, the airbag device M1 is mounted on a vehicle V1.

With the airbag device M1 of the first embodiment, when the actuation circuit detects an impact against a pedestrian based on a signal fed from a sensor mounted on the front bumper 6, the actuator 21 will be actuated so the piston rod 23 pushes up the rear end 10c of the hood 10 as shown in FIG. 11, such that a clearance OS is formed between the rear end 10c of the hood 10 and the cowl 7, as shown in FIG. 12. Generally simultaneously, the inflator 32 will be actuated and inflate the airbag 38, and the airbag 38 will push open the door 30a of the airbag cover 30 and emerge from the emergence opening 26a of the case 26, then protrude rearward and upward and cover the upper surface of the cowl 7 and the front surfaces of the front pillars 5L and 5R, as shown in FIGS. 1 and 12.

In an initial stage of airbag inflation, an inflation gas G discharged from the inflator 32 will firstly inflate the upper reach region 41 of the horizontal inflatable portion 40 and then flow into the lower reach region 42 through the communication holes 48 (or gas outlet region) formed on the tether 47 located at the rear edge 41a of the upper reach region 41. Then the gas G will flow into and inflates the vertical inflatable portions 44. The communication holes 48, i.e., the gas outlet region of the upper reach region 41, which serve to let out an inflation gas G towards the lower reach region 42, are located inward relative to the vertical inflatable portions 44 in a left and right direction at the rear edge 41a of the upper reach region 41. Moreover, the communication holes 48 are so designed as to feed an inflation gas G toward the rear edge 42a of the lower reach region 42. With this configuration, an inflation gas G discharged from the inflator 32 will once fill up the upper reach region 41 and then flow into the lower reach region 42 via the communication holes 48 and flow toward the rear edge 42a of the lower reach region 42. When the gas G hits the rear edge 42a of the lower reach region 42, it will be redirected toward left and right directions, and flow through the lower reach region 42 towards left and right, then flow into the vertical inflatable portions 44. When the gas G reach the vertical inflatable portions 44, it will hit the regions at the outer edges 44c, i.e., the left and right ends, of the vertical inflatable portions 44, and will be redirected again rearward at the root regions 44b of the vertical inflatable portions 44, then flow into the vertical inflatable portions 44.

That is, the configuration of the airbag device M1 of the first embodiment will help prevent an inflation gas G from flowing into the vertical inflatable portions 44 in back and outward directions, and let the gas G be redirected in stages while it flows through the upper reach region 41 and lower reach region 42 before flowing into the vertical inflatable portions 44. When the gas G reaches the vertical inflatable portions 44, the gas G will bulge the root regions 44b of the vertical inflatable portions 44 with the outward directionality suppressed, and flow through the vertical inflatable portions 44 rearward. Accordingly, the vertical inflatable portions 44 will be prevented from oscillating in a left and right direction during deployment, and deploy over the front surfaces of the front pillar 5L and 5R in a quick and steady fashion.

Therefore, the airbag device M1 of the first embodiment is capable of deploying the vertical inflatable portions 44 located on opposite ends of the horizontal inflatable portion 40 over the front surfaces of the front pillars 5L and 5R in a quick and steady fashion.

Moreover, the airbag device M1 of the first embodiment includes inside the horizontal inflatable portion 40 a tether 47 that extends over a generally entire length in a left and right direction and partitions an interior of the horizontal inflatable portion 40 into front and rear. The communication holes 48, which constitute the gas outlet region, are formed on the tether 47. That is, the tether 47 is arranged over a generally entire area in a left and right direction inside the horizontal inflatable portion 40 to partition the upper reach region 41 and lower reach region 42. Further in other words, at full inflation of the airbag, the upper reach region 41 will be deployed over an entire left-right region of the horizontal inflatable portion 40 in an inflated state and reinforce the connecting regions between the lower reach region 42 and vertical inflatable portions 44, when an inflation gas G flows into the vertical inflatable portions 44, since the upper reach region 41 has been already inflated and will work as a rigid body in a shape of a rod including the left and right ends. Further, the communication holes 48 providing communication between the upper reach region 41 and lower reach region 42 are located inward relative to the vertical inflatable portions 44 in a left and right direction. In other words, the upper reach region 41 is so designed as to be closed at the left and right ends. Accordingly, the upper reach region 41 will not lose its rigidity at the left and right ends during inflation of the vertical inflatable portions 44 and securely support the connecting regions between the lower reach region 42 and vertical inflatable portions 44. This will prevent the vertical inflatable portions 44 from swinging or oscillating in a left and right direction.

Furthermore, a total opening area of the communication holes 48 is generally coincident with a sum of the sectional areas A1 (FIG. 8) of the vertical inflatable portions 44 as fully inflated at vicinities of connecting regions with the horizontal inflatable portion 40 (i.e., sectional areas at the root regions 44b of the vertical inflatable portions 44). This configuration will enable the vertical inflatable portions 44 to inflate quickly although an inflation gas makes a detour through the lower reach region 42 before flowing into the vertical inflatable portions 44. Further, the upper reach region 41 will be prevented from undue increase in internal pressure. If such advantages do not have to be considered, the total opening area of the communication holes 48 may be larger or smaller relative to the sectional areas of the root regions 44b of the vertical inflatable portions 44 in some degree. If the total opening area of the communication holes 48 is considerably larger than the sectional areas of the root regions 44b of the vertical inflatable portions 44, an inflation gas is likely to flow into the vertical inflatable portions via the lower reach region before the upper reach region is inflated entirely in a left and right direction, which will hinder the upper reach region from gaining enough rigidity at inflation of the vertical inflatable portions.

In the first embodiment, especially, the communication holes 48 are provided numerously in such a manner as to form double horizontal lines extending across a region of the tether 47 located inward relative to the vertical inflatable portions 44. In other words, the communication holes 48, each having a small opening area, are arranged intermittently and extensively in a left and right direction of the tether 47. Compared with an instance where fewer and larger communication holes are provided, this configuration will make it easier to redirect an inflation gas G when the gas flows into the lower reach region 42 from the upper reach region 41 via the communication holes 48, i.e., to redirect the gas G toward the rear edge 42a of the lower reach region 42, otherwise the gas would flow outwardly in a left and right direction, i.e., directly toward the vertical inflatable portions 44. Further, although the opening area of each of the communication holes 48 is small, the round shape of each of the holes 48 will reduce stress concentration which would otherwise occur on the peripheral edge of each of the holes when an inflation gas goes therethrough.

In the first embodiment, the airbag 38 is folded up through the front-rear contraction step and the left-right contraction step. In the front-rear contraction step, the vertical inflatable portions 44 as flattened are rolled on the lower wall 39a from the rear ends or leading ends 44a, and in the left-right contraction step, the left and right ends 60a and 60b of the front-rear contracted bag 60 are brought close to the center in a left and right direction such that the vertical inflatable portions 44 are folded back toward the horizontal inflatable portion 40. When fed with an inflation gas upon deployment, the airbag 38 will firstly unfurl in such a manner as to undo the folds formed in the left-right contraction step, and then unfurl and inflate in such a manner as to undo the folds made in the front-rear contraction step. Since the vertical inflatable portions 44 are folded back toward the horizontal inflatable portion 40 in the left-right contraction step, the front-rear contracted bag 60 will unfurl the vertical inflatable portions 44 quickly towards left and right when the upper reach region 41 is fed with an inflation gas in an initial stage of airbag inflation. Further, since the vertical inflatable portions 44 are rolled on the lower wall 39a from the rear ends or leading ends 44a, they will roll out along the front surfaces of the front pillars 5L and 5R upon deployment, rather than oscillating or floating up from the front pillars 5L and 5R while unfurling. Consequently, the vertical inflatable portions 44 will deploy quickly over the front pillars 5L and 5R.

Further, in the front-rear contraction step, about a front half region of the airbag 38 where the tether 47 is located is folded in a bellows fashion whereas a rear half region is rolled on the lower side wall 39a. That is, in the illustrated embodiment, the upper reach region 41 of the horizontal inflatable portion 40 is generally entirely folded in a bellows fashion except the left and right end regions. This configuration will enable the upper reach region 41 to emerge from the case 26 and unfurl quickly over a generally entire region in a left and right direction in an initial stage of airbag inflation, such that the upper reach region 41 inflates into a rod shape extending in a left and right direction and gains rigidity. Then the vertical inflatable portions 44 will unroll and unfurl. Thus, although the horizontal inflatable portion 40 is elongated generally in a left and right direction and curves relative to a left and right direction, it will be prevented from twisting at an intermediate region, and the vertical inflatable portions 44 will unfurl smoothly as well since they are supported by the horizontal inflatable portion 40 at the root regions 44b. Further, in the illustrated embodiment, the rear end 10c of the vehicle hood 10 is lifted by the actuator 21 upon deployment of the airbag 38, and therefore, when the upper reach region 41 of the horizontal inflatable portion 40 unfurls rearward in an initial stage of deployment, the airbag 38 will easily climb over the wipers 8 located on the cowl louver 7b immediately at the rear of the case 26 during deployment.

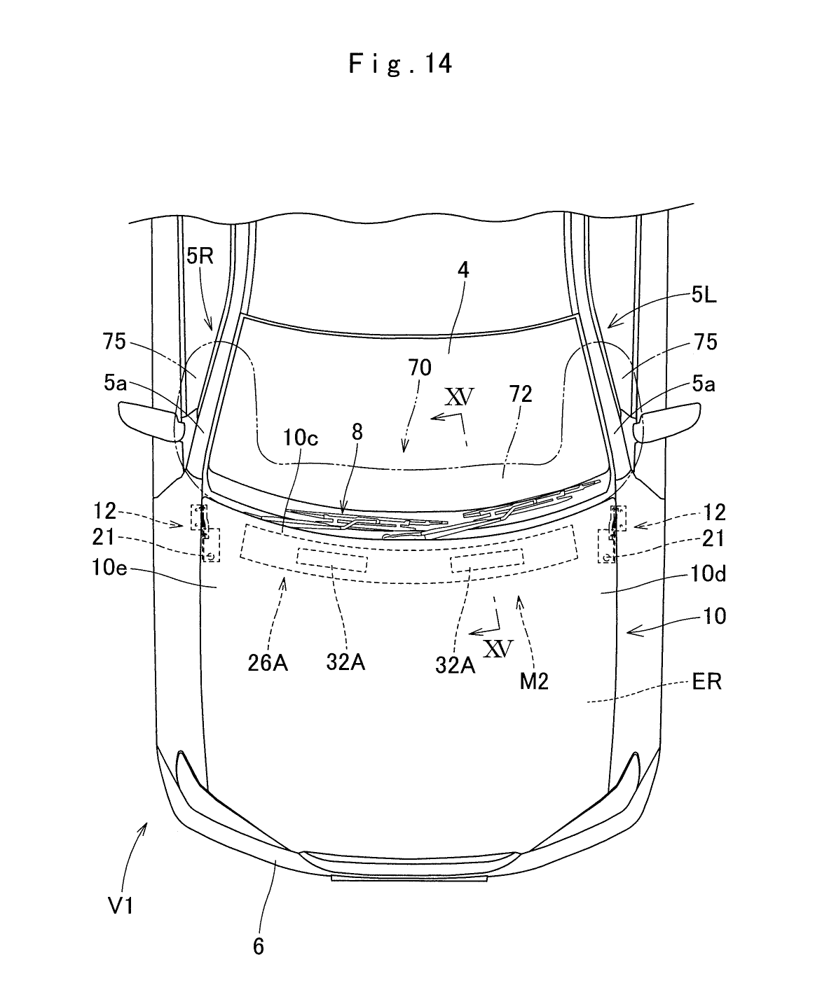

The second embodiment of the invention is now described with reference to FIGS. 14 to 23. A pedestrian protection airbag device M2 according to the second embodiment is located at a vicinity of the center in a left and right direction of a vehicle V1 between the left and right front pillars 5L and 5R, at the rear end 10c of the vehicle hood 10 of the vehicle V1. Since the vehicle V1 has a similar configuration to the vehicle V1 in the first embodiment, common reference numerals will be assigned to common members and detailed descriptions will be omitted for such members.

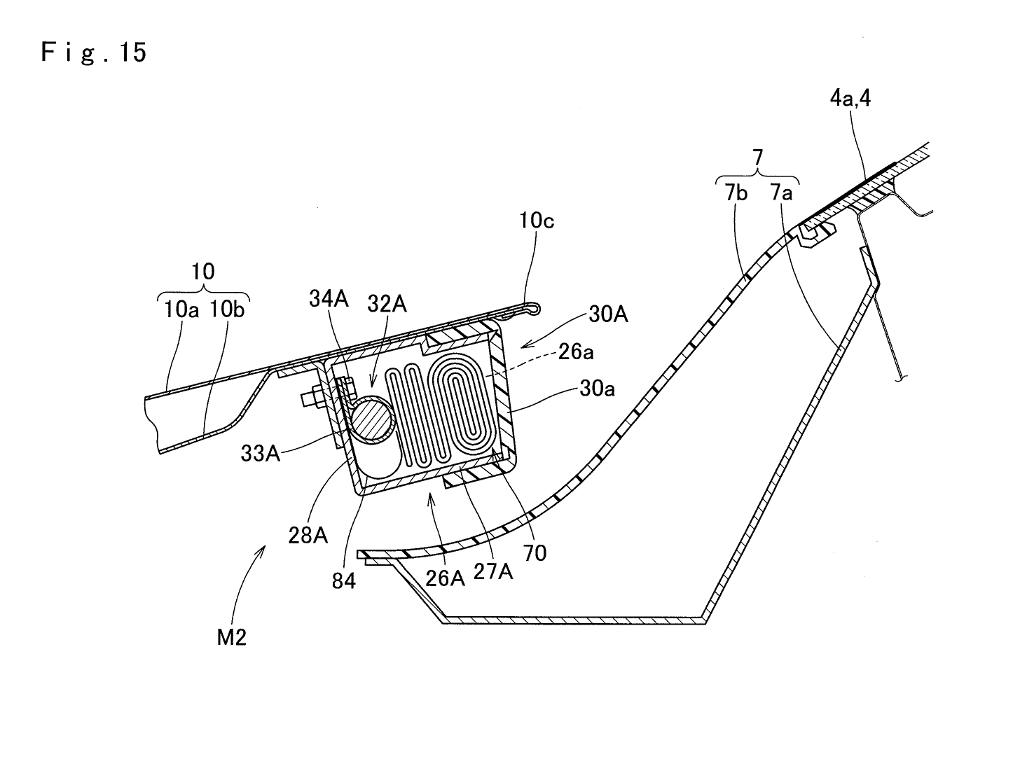

Referring to FIGS. 14 and 15, the airbag device M2 includes an airbag 70, an inflator 32A that feeds an inflation gas to the airbag 70, a case or housing 26A that houses the airbag 70 and inflator 32A, and an airbag cover 30A that covers the airbag 70 in a folded-up configuration. The airbag device M2 has a similar configuration to the airbag device M1 of the first embodiment except in the airbag 70 and in using two inflators 32A. Therefore, detailed descriptions on common members will be omitted and each of the common members will be referred to with the same reference numeral plus “A”. As shown in FIG. 15, the case 26A of the second embodiment is also directly joined to the underside of the vehicle hood 10 by a bracket (reference numeral omitted) at the rear end 10c of the hood 10. As shown in FIG. 14, the airbag device M2 includes two inflators 32A, which are located on the left side and right side of the case 26A. Each of the inflators 32A is generally cylindrical in shape and so arranged that the axial direction extends along a left and right direction. The inflators 32A have gas discharge ports (unillustrated) for discharging an inflation gas on their ends facing away from each other.

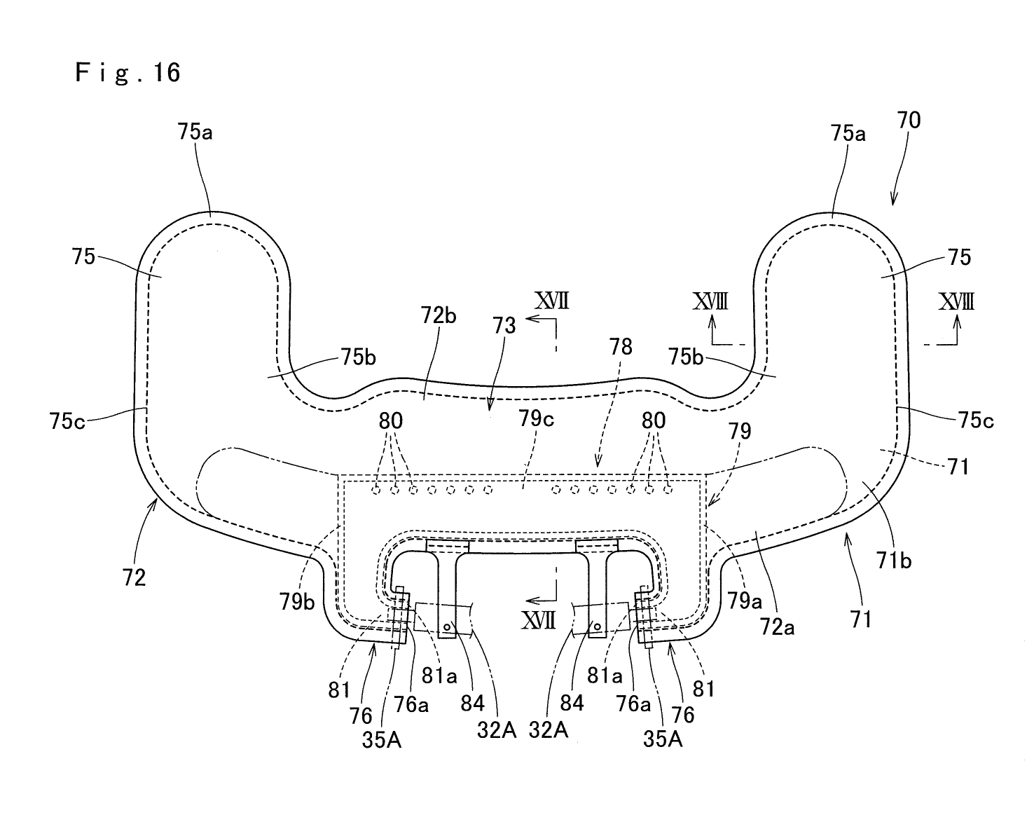

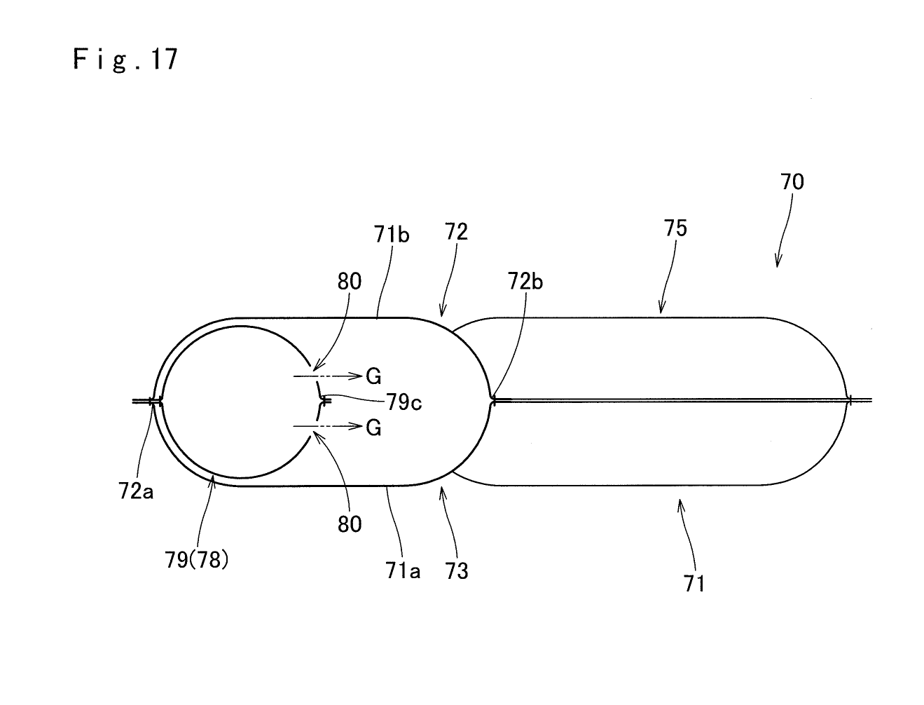

As shown in FIGS. 16 and 17, the airbag 70 includes a bag body 71 inflatable with an inflation gas, an inner bag 78 located inside the horizontal inflatable portion 72 of the bag body 71, a pair of mounting portions 84 serving to mount the bag body 71 on the case 26A.

As indicated by double-dotted lines in FIG. 14 and shown in FIG. 16, the bag body 71 is inflatable into a generally U shape elongated in a left and right direction as viewed from the front. The bag body 71 includes a horizontal inflatable portion 72 that extends in a left and right direction along the lower region 4a of the front windshield 4 upon deployment, two vertical inflatable portions 75 that extend rearward from opposite ends of the horizontal inflatable portion 72 and cover the front surfaces of the front pillars 5L and 5R, and two gas inlet ports 76 that are formed at the front edge 72a of the horizontal inflatable portion 72 and are connected with the inflators 32A. In the illustrated embodiment, as shown in FIGS. 16, 17 and 20, the bag body 71 is formed of a lower wall 71a deployable at the lower side and an upper wall 71b deployable at the upper side, which walls 71a and 71b are generally identical in outer contour and are sewn (joined) together by the circumferential edges with sewing threads except at the leading ends 76a of the gas inlet ports 76.

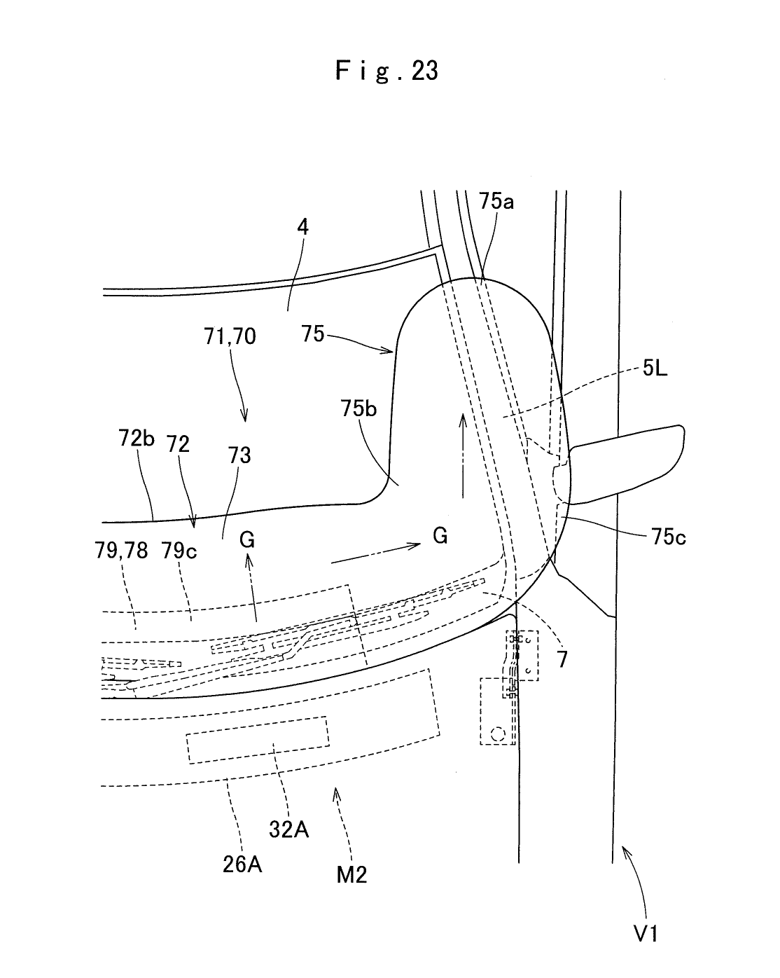

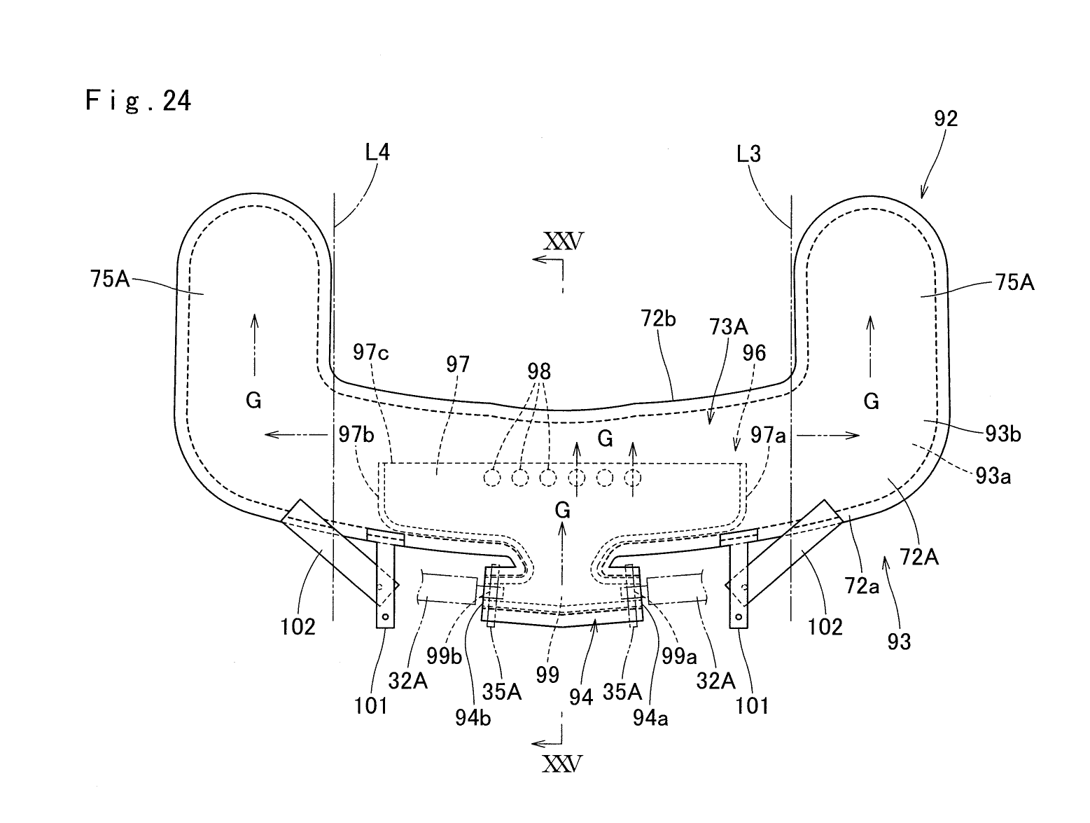

As indicated by double-dotted lines in FIG. 14 and shown in FIG. 23, the horizontal inflatable portion 72 is designed to cover the upper surface of an area ranging from the cowl 7 to the lower region 4a of the front windshield 4, including the wipers 8, and is inflatable into a rod shape curving relative to a left and right direction, along the curvature of the rear end 10c of the hood 10, such that the center in a left and right direction is located forward whereas left and right end regions located rearward. More specifically, the horizontal inflatable portion 72 is so designed that its front edge region 72a is located at the rear of and right adjacent to the rear end 10c of the hood 10 upon deployment, as shown in FIG. 22.

The vertical inflatable portions 75 are deployable over the front surfaces of the front pillars 5L and 5R. The width in a left and right direction of each of the vertical inflatable portions 75 in a flattened state is slightly smaller than the width in a front and rear direction of the horizontal inflatable portion 72 in a flattened state. More specifically, each of the vertical inflatable portions 75 is so sized in length as to cover generally entire front surfaces of the front pillars 5L and 5R.

As shown in FIG. 16, the gas inlet ports 76 are located inward relative to the vertical inflatable portions 75 in a left and right direction and protrude forward from the front edge 72a of the horizontal inflatable portion 72 bilaterally symmetrically. The leading ends 76a of the gas inlet ports 76 are open so as to be connected to the inflators 32A and oppose each other.

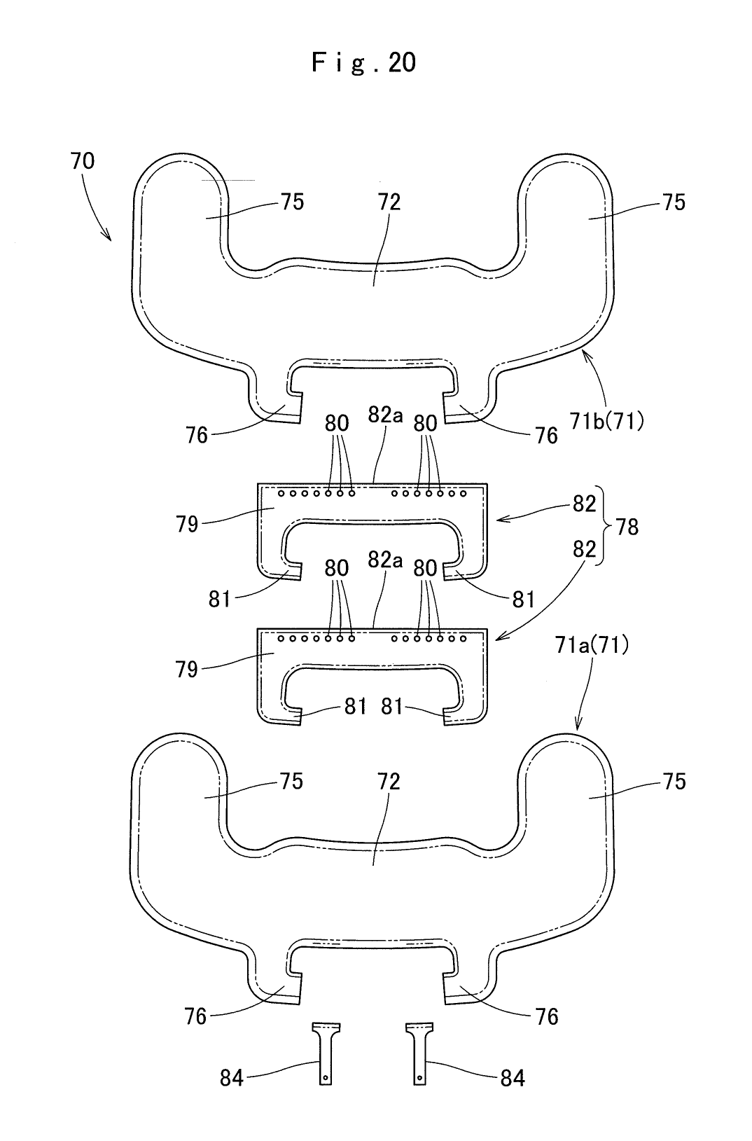

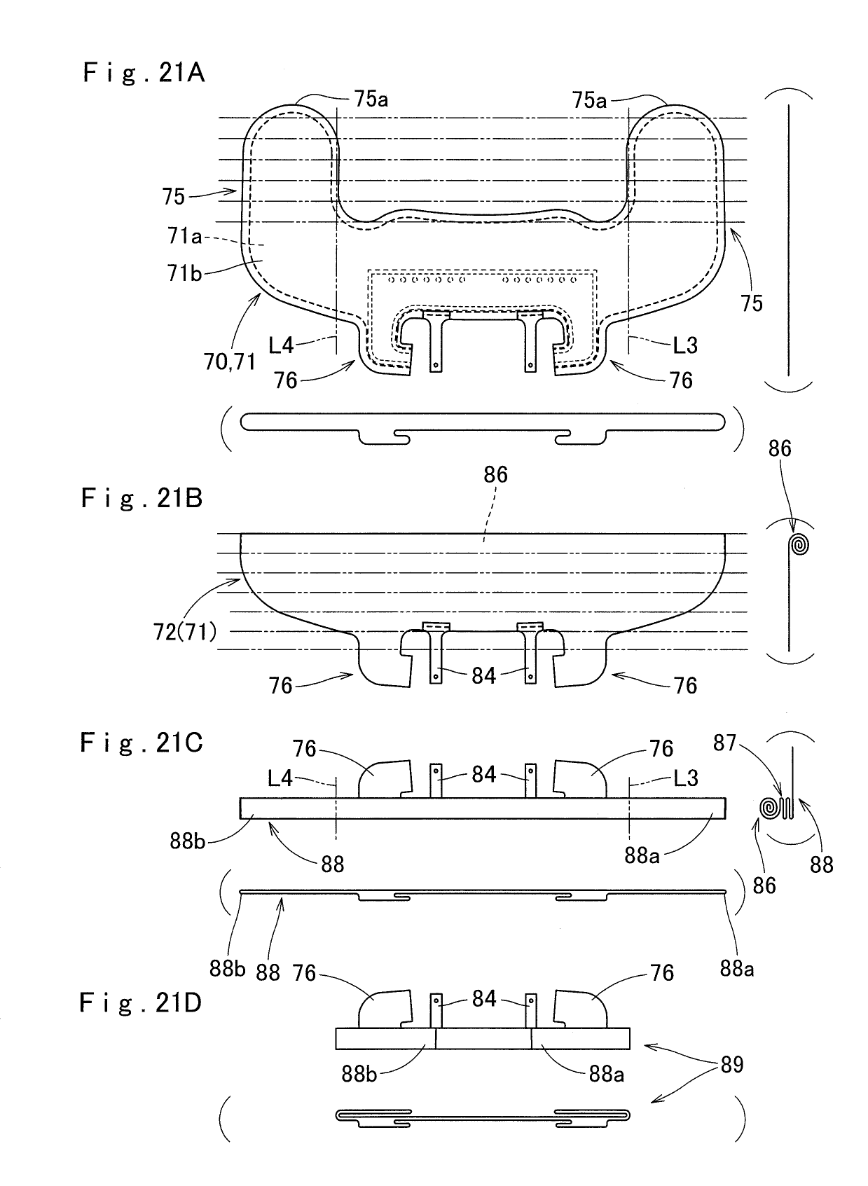

The inner bag 78 is provided separate from the bag body 71 and located inside the horizontal inflatable portion 72. As shown in FIG. 19, the inner bag 78 includes a main body 79 located at a region toward the front edge 72a of the horizontal inflatable portion 72 and two conduits 81 extending forward from the main body 79 and located inside the gas inlet ports 76. As shown in FIG. 20, the inner bag 78 of the illustrated embodiment is formed of two generally identical base materials 82 that are sewn (joined) together by the circumferential edges with sewing threads except at the leading ends 81a of the conduits 81.

As shown in FIGS. 16 and 17, the main body 79 is located at the region toward the front edge 72a of the horizontal inflatable portion 72 and at the center in a left and right direction of the horizontal inflatable portion 72. The main body 79 is inflatable into a rod extending generally in a left and right direction, generally along the horizontal inflatable portion 72. The width in a front and rear direction of the main body 79 in a flattened state is about a half of the width in a front and rear direction of the horizontal inflatable portion 72 in a flattened state. The length in a left and right direction of the main body 79 is generally identical to the distance between the outer edges of the gas inlet ports 76 of the horizontal inflatable portion 72 in a left and right direction. Thus the main body 79 is located at the region toward the front edge 72a of the horizontal inflatable portion 72 and between the gas inlet ports 76. In other words, the opposite ends 79a and 79b of the main body 79 in a left and right direction are located inward relative to the vertical inflatable portions 75 in a left and right direction, as shown in FIG. 16. The conduits 81 protrude forward from the left and right ends of the main body 79 and line the inner side of the gas inlet ports 76 entirely, so as to be joined to the inflators 32A together with the gas inlet ports 76. In the second embodiment, an inflation gas discharged from the inflators 32A firstly flows into the main body 79 of the inner bag 78 via the conduits 81, thus the inner bag 78 serves as an upper reach region which is located at an upper reach of a stream of an inflation gas discharged from the inflators 32A. The region of the horizontal inflatable portion 72 except the inner bag 78, i.e., the regions located at the rear of the main body 79 and located on the left and right sides of the main body 79, constitute a lower reach region 73.

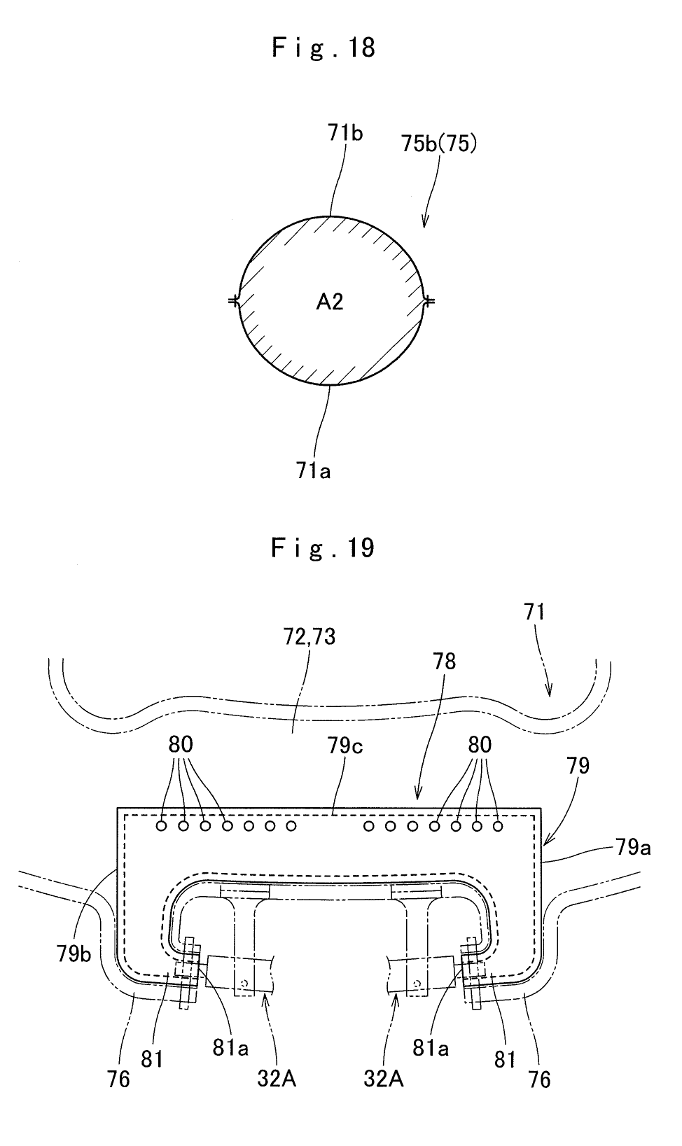

The inner bag 78 includes at the rear edge 79c of the main body 79 at full deployment a plurality of outlet holes 80 through which an inflation gas is fed to the lower reach region 73. The outlet holes 80 constitute a gas outlet region that serves to feed an inflation gas G toward the rear edge 72b of the horizontal inflatable portion 72 (i.e., of the lower reach region 73). Each of the outlet holes 80 is generally round. In the illustrated embodiment, as shown in FIG. 20, there are formed twenty-eight outlet holes 80 in total; each 7 holes are located on the left side and right sides of the rear edge 82a of each of the base materials 82 of the inner bag 78. The total opening area of the outlet holes 80 (i.e., of the gas outlet region) is generally coincident with a sum of sectional areas A2 (FIG. 18) of the vertical inflatable portions 75 as fully inflated at vicinities of connecting regions with the horizontal inflatable portion 72 (i.e., sectional areas at the root regions 75b of the vertical inflatable portions 75).

The mounting portions 84 are used to mount the bag body 71 on the case 26A. As shown in FIG. 16, the mounting portions 84 extend forward from the front edge 72a of the horizontal inflatable portion 72. In the illustrated embodiment, two mounting portions 84 are provided inward of the gas inlet ports 76 in a left and right direction. Each of the mounting portions 84 includes at the leading end an insert hole (reference numeral omitted) for receiving a bolt 34A which is used to mount the inflator 32A on the case 26A. That is, the mounting portions 84 are fastened with the bolts 34A to the bottom wall 28A of the case 26A together with the inflators 32A, as shown in FIG. 15.

The bag body 71, inner bag 78 and mounting portions 84 of the second embodiment are also made of a woven fabric of polyester yarn, polyamide yarn or the like and coated with a coating agent for preventing gas leakage.

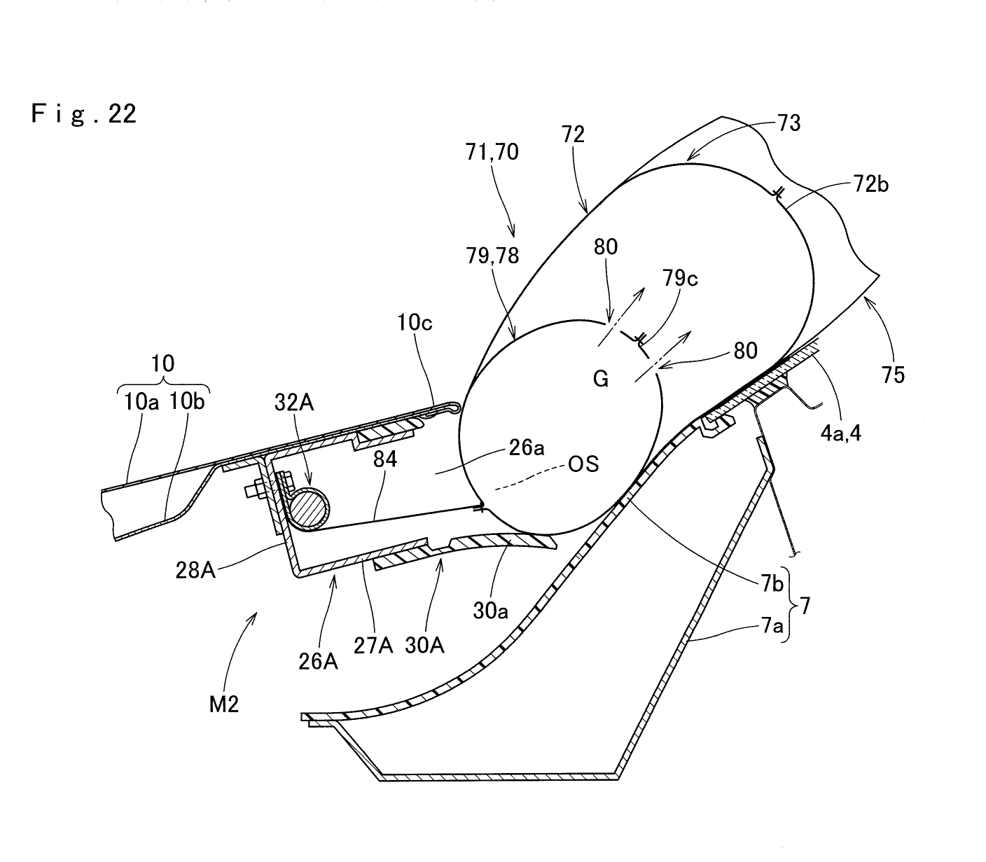

The airbag 70 of the second embodiment is folded up as follows, from a flattened state where the upper wall 71b and lower wall 71a overlap with each other: Firstly, as shown in FIG. 21A, the vertical inflatable portions 75 are rolled on the lower wall 71a from the rear ends or leading ends 75a, thereby forming a rolled portion 86. Then the horizontal inflatable portion 72 and gas inlet ports 76 are folded in a bellows fashion on creases extending along a left and right direction, thereby forming a bellows-folded portion 87, as shown in FIGS. 21B and 21C. Thus the front-rear contraction step is completed. The airbag in this state is referred to as a front-rear contracted bag 88. Subsequently, the front-rear contracted bag 88 is folded back on creases L3 and L4 extending along a front and rear direction, as shown in FIG. 21C, at the positions between the vertical inflatable portions 75 and the main body 79 of the inner bag 78, which are inward of the vertical inflatable portions 75 in a left and right direction, i.e., outward of the outlet ports 80, and proximate to the left and right ends 79a and 79b of the main body 79, such that the left and right ends 88a and 88b of the front-rear contracted bag 88 are brought towards and directed to the center in a left and right direction. Thus the left-right contraction step is completed as shown in FIG. 21D and a completely-folded body 89, which fits in the case 26A, is provided. Thereafter, in a similar fashion to the first embodiment, the airbag device M2 is mounted on the vehicle V1.

In operation, in an initial stage of airbag inflation, an inflation gas G fed from the inflators 32A inflates firstly the main body 79 of the inner bag 78 (i.e., the upper reach region) inside the horizontal inflatable portion 72, and then flows into the lower reach region 73 of the horizontal inflatable portion 72 via the outlet ports 80 formed on the main body 79 as shown in FIG. 22, and then flows into and inflates the vertical inflatable portions 75. The outlet ports 80 of the inner bag 78, which let out an inflation gas towards the lower reach region 73, are located inward relative to the vertical inflatable portion 75 in a left and right direction at the rear edge 79c of the main body 79. Moreover, the outlet holes 80 are so designed as to feed an inflation gas G toward the rear edge 72a of the horizontal inflatable portion 72 which serves as the lower reach region 73.

With this configuration, an inflation gas G discharged from the inflators 32A will once fill up the main body 79 of the inner bag 78 and then flow into the lower reach region 73 via the outlet holes 80 and flow toward the rear edge 72a of the horizontal inflatable portion 72. When the gas G hits the rear edge 72a of the horizontal inflatable portion 72, it will be redirected toward left and right directions, and flow through the horizontal inflatable portion 72 (i.e., through the lower reach region 73) towards left and right, then flow into the vertical inflatable portions 75. When the gas G flows into the vertical inflatable portions 75, it will hit the outer edges 75c, i.e., the left and right ends, of the vertical inflatable portions 75, and be redirected again rearward at the root regions 75b of the vertical inflatable portions 75, then flow into the vertical inflatable portions 75.

That is, the configuration of the airbag device M2 of the second embodiment will help prevent an inflation gas G from flowing into the vertical inflatable portions 75 in back and outward directions, and let the gas G be redirected in stages while it flows through the main body 79 of the inner bag 78 (i.e., the upper reach region) and lower reach region 73 before flowing into the vertical inflatable portions 75. When the gas G reaches the vertical inflatable portions 75, it will bulge the root regions 75b firstly and flow through the vertical inflatable portions 75 rearward, with the outward directionality suppressed. Accordingly, the vertical inflatable portions 75 will be prevented from oscillating in a left and right direction during deployment, and deploy over the front surfaces of the front pillar 5L and 5R in a quick and steady fashion.

Therefore, the airbag device M2 of the second embodiment is capable of deploying the vertical inflatable portions 75 located on opposite ends of the horizontal inflatable portion 72 over the front surfaces of the front pillars 5L and 5R in a quick and steady fashion.

In the second embodiment, the main body 79 of the inner bag 78 is so designed that the left and right ends 79a and 79b are located inward relative to the vertical inflatable portions 75 in a left and right direction. This configuration will make the inner bag 78 compact in size, and accordingly make the airbag 70 in a folded-up configuration compact so as to be easily housed in the case 26A. If such an advantage does not have to be considered, the main body of the inner bag may alternatively be extended in a left and right direction, up to the regions in front of the vertical inflatable portions, as indicated by double-dotted lines in FIG. 16. However, even in such an instance, the outlet holes formed at the rear edge of the main body should be located inward relative to the vertical inflatable portions in a left and right direction.

Moreover, a total opening area of the outlet holes 80 is generally coincident with a sum of the sectional areas A2 (FIG. 18) of the vertical inflatable portions 75 as fully inflated at vicinities of connecting regions with the horizontal inflatable portion 72 (i.e., sectional areas at the root regions 75b of the vertical inflatable portions 75). This configuration will enable the vertical inflatable portions 75 to inflate quickly although an inflation gas makes a detour through the lower reach region 73 before flowing into the vertical inflatable portions 75. Further, the inner bag 78 will be prevented from undue increase in internal pressure. In the second embodiment, especially, similarly to the first embodiment, the outlet holes 80 are provided on the main body 79 of the inner bag 78 numerously in such a manner as to form double horizontal lines extending across a region located inward relative to the vertical inflatable portions 75. This configuration will make it easier to redirect an inflation gas G when the gas flows into the lower reach region 73 from the main body 79 of the inner bag 78 via the outlet holes 80, i.e., to redirect the gas G toward the rear edge 72a of the lower reach region 73, otherwise the gas would flow outwardly in a left and right direction, i.e., directly toward the vertical inflatable portions 75. Further, although the opening area of each of the outlet holes 80 is small, the round shape of each of the holes 80 will reduce stress concentration which would otherwise occur on the peripheral edge of each of the holes when an inflation gas goes therethrough.

Also in the second embodiment, the airbag 70 is folded up through the front-rear contraction step and the left-right contraction step. In the front-rear contraction step, the vertical inflatable portions 75 as flattened are rolled on the lower wall 71a from the rear ends or leading ends 75a, and in the left-right contraction step, the left and right ends 88a and 88b of the front-rear contracted bag 88 are brought close to the center in a left and right direction such that the vertical inflatable portions 75 are folded back toward the horizontal inflatable portion 72. With this configuration, in an initial stage of airbag deployment, the folds made in the left-right contraction step will be undone and the airbag 70 will unfurl the vertical inflatable portions 75 quickly towards left and right, and then the vertical inflatable portions 75 will roll out along the front surfaces of the front pillars 5L and 5R rather than oscillating or floating up from the front pillars 5L and 5R while unfurling. Consequently, the vertical inflatable portions 75 will deploy quickly over the front pillars 5L and 5R.

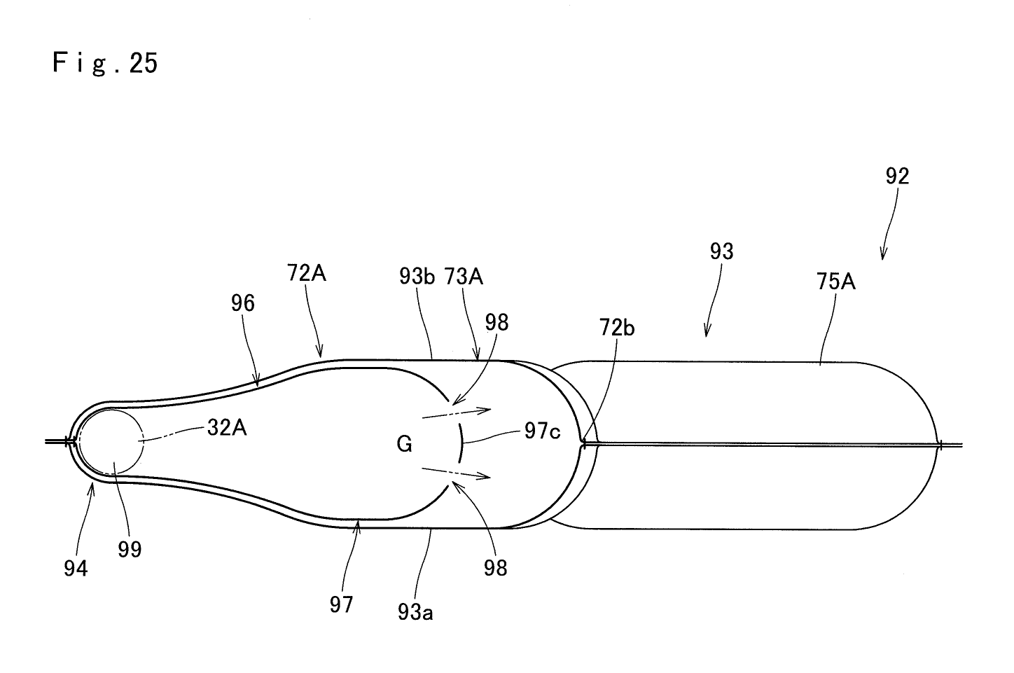

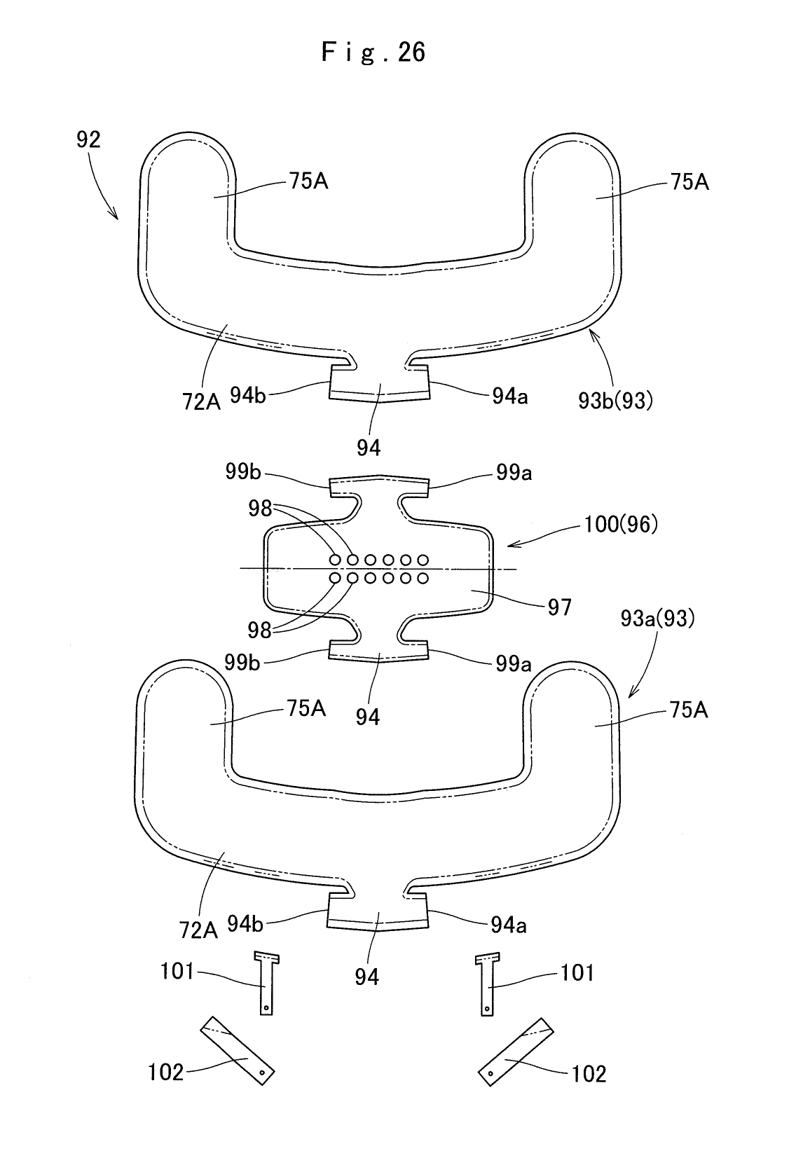

FIGS. 24 and 25 depict an airbag 92 as a modification of the second embodiment, which also includes an inner bag. The airbag 92 has a similar configuration to the airbag 70 except in a gas inlet portion 94 of a bag body 93, an inner bag 96 and mounting portions 101 and 102. Therefore, detailed descriptions on common members will be omitted and each of the common members will be referred to with the same reference numeral plus “A”.

As shown in FIGS. 24 to 26, the bag body 93 of the airbag 92 is formed of a lower wall 93a deployable at the lower side and an upper wall 93b deployable at the upper side, which walls 93a and 93b are generally identical in outer contour and are sewn (joined) together by the circumferential edges with sewing threads except at right and left ends 94a and 94b of the gas inlet portion 94. The width in a left and right direction of each of the vertical inflatable portions 75A in a flattened state is generally identical to the width in a front and rear direction of the horizontal inflatable portion 72A in a flattened state. The gas inlet portion 94 protrudes forward from the front edge 72a of the horizontal inflatable portion 72A, generally at the center in a left and right direction of the horizontal inflatable portion 72A As shown in FIG. 24, the gas inlet portion 94 is formed into a generally “T” and is open at the left and right ends 94a and 94b to be connected with inflators 32A.

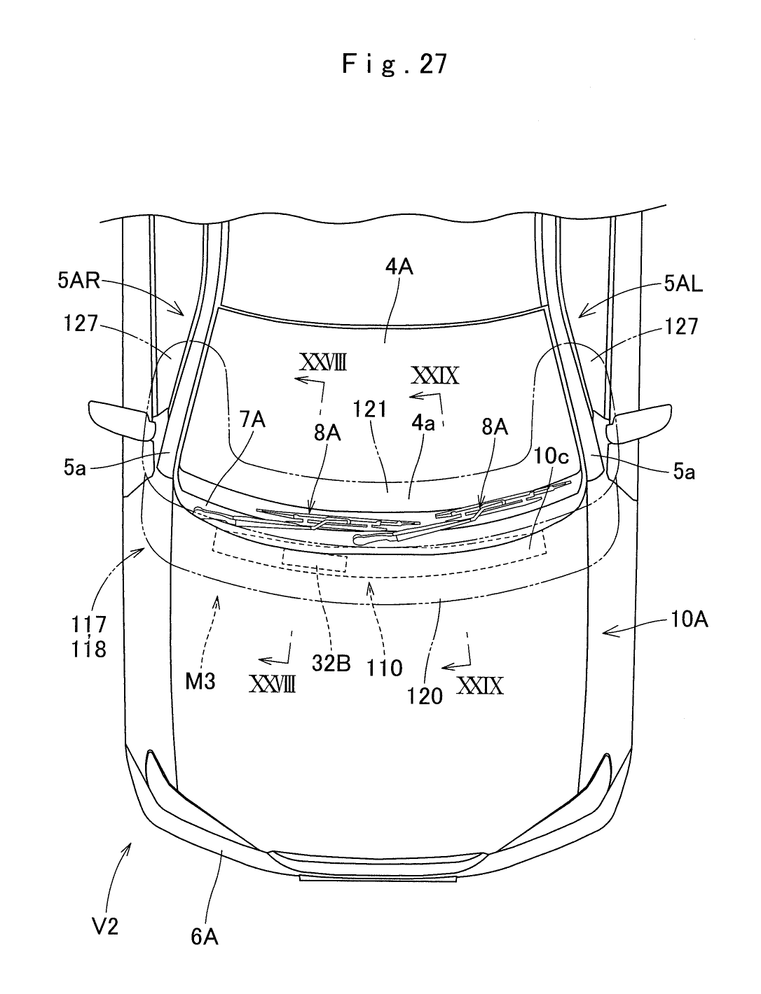

The inner bag 96 is provided separate from the bag body 93 and located inside the horizontal inflatable portion 72A. The inner bag 96 includes a main body 97 located at a region toward the front edge 72a of the horizontal inflatable portion 72A and a conduit 99 extending forward from the main body 97 and located inside the gas inlet portion 94. As shown in FIG. 26, the inner bag 96 of this specific embodiment is formed of a base material 100 that is folded in the middle, which is to be the rear edge of the inner bag 96, and is sewn up (joined) by the circumferential edge with sewing threads except at left and right ends 99a and 99b of the conduit 99. Similarly to the main body 79 of the inner bag 78 in the second embodiment, the main body 97 is located at the region toward the front edge 72a of the horizontal inflatable portion 72A, at the center in a left and right direction of the horizontal inflatable portion 72A. The main body 97 is similar in outer contour to the main body 79. Left and right ends 97a and 97b of the main body 79 are located inward relative to the vertical inflatable portions 75A in a left and right direction and at the rear of the mounting portions 101. The conduit 99 protrudes forward from a generally center in a left and right direction of the front edge of the main body 97 and lines the inner side of the gas inlet portion 94 entirely, so as to be joined to the inflators 32A together with the gas inlet portion 94. Also in the airbag 92, an inflation gas G discharged from the inflators 32A firstly flows into the main body 97 of the inner bag 96 via the conduit 99, from a vicinity of the center in a left and right direction of the front edge of the main body 97. Thus the inner bag 96 serves as an upper reach region whereas the region of the horizontal inflatable portion 72A except the inner bag 96, i.e., the regions located at the rear of the main body 97 and on the left and right sides of the main body 97, constitute a lower reach region 73A.

As shown in FIGS. 24 and 25, the inner bag 96 includes at the rear edge 97c of the main body 97 at full deployment a plurality of outlet holes 98 (i.e., gas outlet region). The outlet holes 98 let out an inflation gas G toward the rear edge 72b of the horizontal inflatable portion 72A (i.e., of the lower reach region 73A). As shown in FIG. 26, the outlet holes 98 form each one horizontal line on the top- and undersides of the inner bag 96 as flattened at the rear edge 97c, and each of the horizontal line is comprised of 6 holes. These outlet holes 98 are located generally at the center in a left and right direction of the rear edge 97c of the main body 97, at the rear of the conduit 99 (i.e., at the rear of the gas inlet portion 94 of the airbag 92). A total opening area of the outlet holes 98 (i.e., of the gas outlet region) is generally coincident with a sum of sectional areas of the vertical inflatable portions 75A as fully inflated at vicinities of connecting regions with the horizontal inflatable portion 72A (Le., sectional areas at the root regions 75b of the vertical inflatable portions 75A).

Each of the mounting portions 101 and 102 is formed into a generally band shape and extends forward from the front edge 72a of the horizontal inflatable portion 72A. The mounting portions 101 extend generally along a front and rear direction from the front of the left and right ends 97a and 97b of the main body 97 of the inner bag 96 whereas the mounting portions 102 are located at the outside of the mounting portions 101 in a left and right direction, at vicinities of connecting regions between the vertical inflatable portions 75A and horizontal inflatable portion 72A, and extend diagonally relative to a front and rear direction and inwardly in a left and right direction. The mounting portions 101 and 102 are bolt fixed to an unillustrated case.

The airbag 92 is mounted on a vehicle V1 in a similar fashion to the above-described airbag 70. With the airbag 92, the same effect is achieved as in an instance where the airbag device with the airbag 70 is used. In the airbag 92, the conduit 99 of the inner bag 96 extends forward from a generally center in a left and right direction of the main body 97 and is joined with the inflators. The outlet holes 98 are located generally at the center in a left and right direction of the main body 97, at the rear of the conduit 99, in a bilaterally symmetrical fashion relative to the center in a left and right direction. With this configuration, an inflation gas discharged from the inflators will flow into the horizontal inflatable portion 72A, via the inner bag 96, from the center in a left and right direction of the horizontal inflatable portion 72A, such that the horizontal inflatable portion 72A will start to inflate from the center in a left and right direction, unlike the inner bag 78 of the airbag 70 in which the conduit 81 and outlet holes 80 are located to the left and right relative to the center in a left and right direction. Consequently, the vertical inflatable portions 75A will inflate while the horizontal inflatable portion 72A is sufficiently inflated as a whole from the center to the opposite ends in a left and right direction.

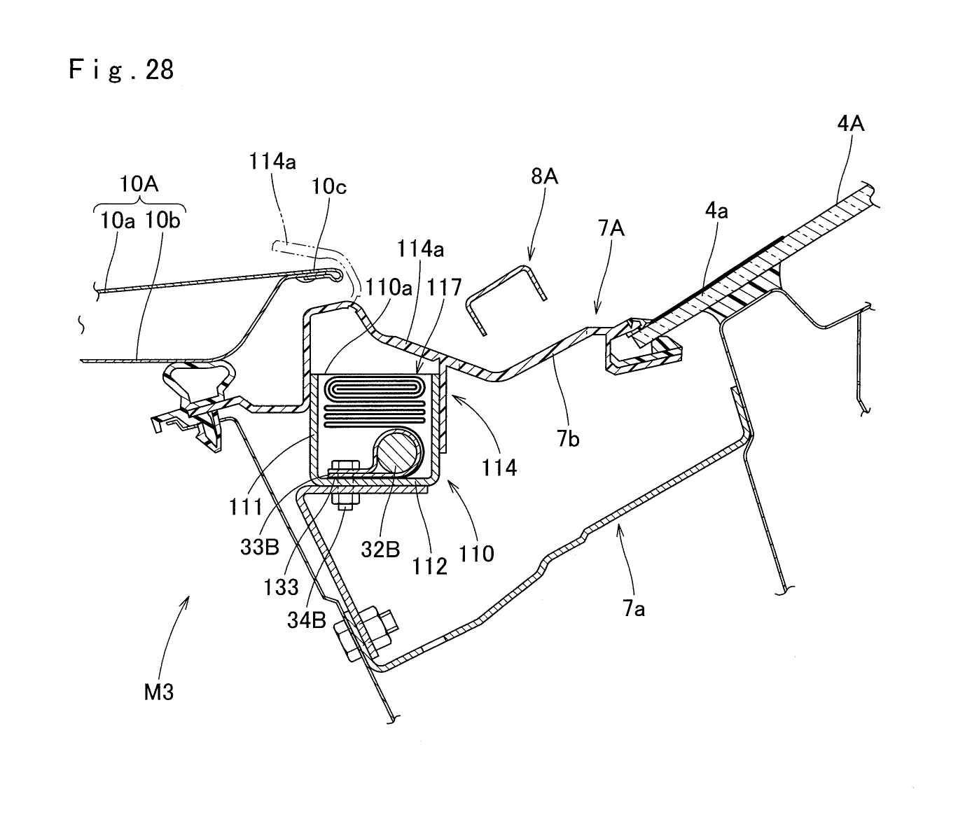

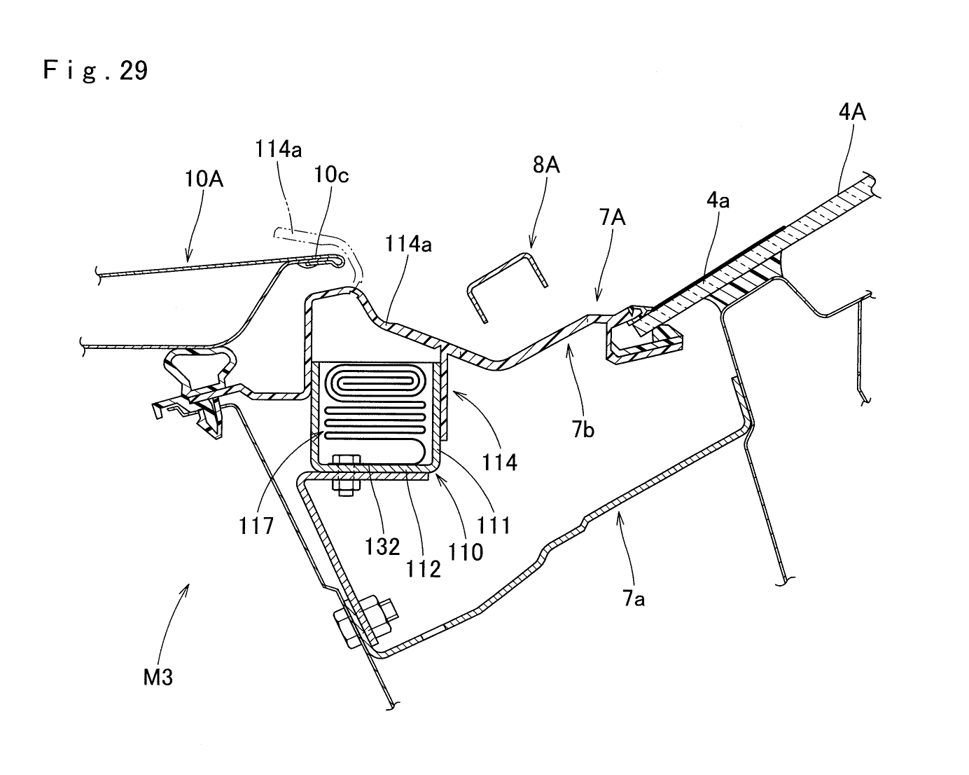

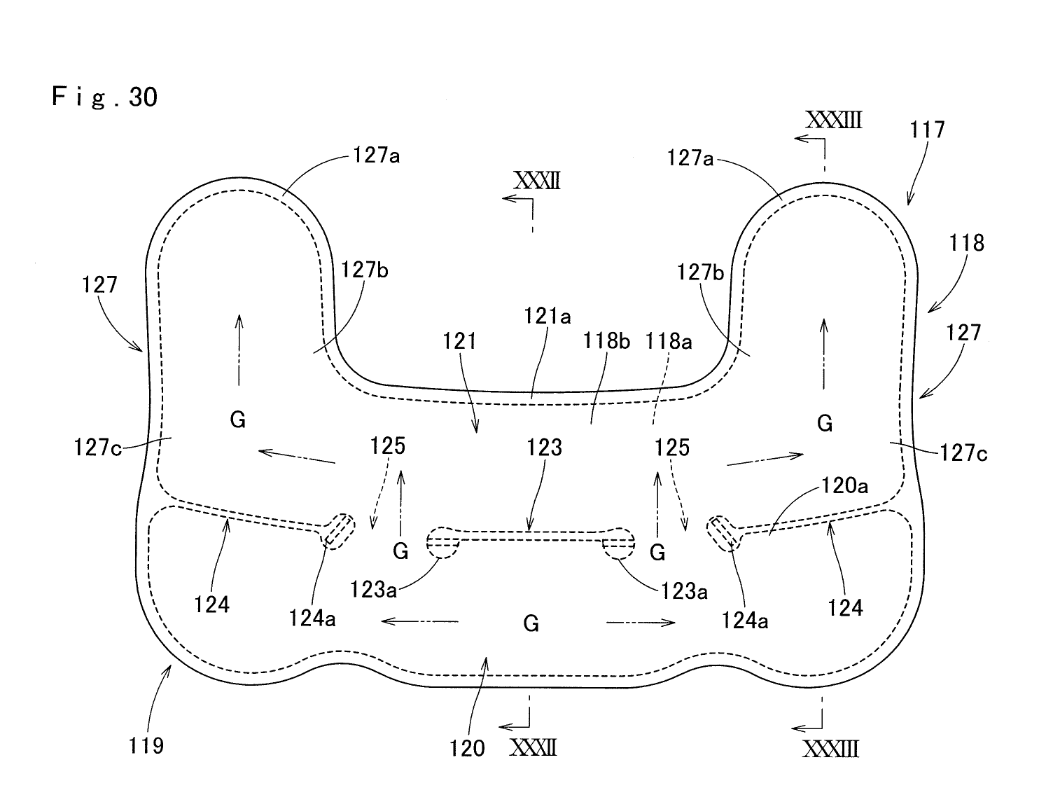

The third embodiment of the invention is now described. An airbag device M3 according to the third embodiment is mounted on a vehicle V2 shown in FIGS. 27 and 28. As shown in FIGS. 28 and 29, the vehicle V2 has a cowl 7A with a wide width in a front and rear direction. The airbag device M3 is located beneath the cowl 7A. The vehicle V2 is not provided with an actuator for lifting the rear end 10c of the vehicle hood 10A. However, the vehicle V2 has a similar configuration to the vehicle V1 except the actuator, and therefore, detailed descriptions on common members will be omitted and each of the common members will be referred to with the same reference numeral plus “A”.

The airbag device M3 includes an airbag 117, an inflator 32B that feeds an inflation gas to the airbag 117, a case or housing 110 that houses the airbag 117 and inflator 32B, and an airbag cover 114 that covers the airbag 117 in a folded-up configuration. As shown in FIG. 27, the inflator 32B is located to the right relative to the center in a left and right direction of the case 110. A detailed description on the inflator 32B will be omitted as the inflator 32B has a similar structure to the inflator 32 of the airbag device M1.

As shown in FIGS. 27 to 29, the case or housing 110 is located at a vicinity of the center in a left and right direction of a vehicle V2, between the left and right front pillars 5AL and 5AR, in a vicinity of the rear end 10c of the vehicle hood 10A of the vehicle V2. In this specific embodiment, the case 110 is located at a cowl 7A, in front of wipers 8A. The case 110 is made of a sheet metal and formed into a generally box shape provided with a generally square tubular circumferential wall 111 opening upward and a bottom wall 112 closing the bottom of the circumferential wall 111, as shown in FIGS. 28 and 29. The airbag 117 emerges from an emergence opening 110a formed at the top of the case 110 upon deployment. In the illustrated embodiment, the case 110 is mounted on a cowl panel 7a of the cowl 7A with brackets (reference numeral omitted) extending from the bottom wall 112. As shown in FIG. 27, the case 110 is so designed in shape as to curve relative to a left and right direction along the curvature of the rear end 10c of the hood 10A such that the center in a left and right direction is located forward whereas left and right end regions are located rearward. More specifically, the left and right ends of the case 110 are located proximate to lower regions of and at inside in a left and right direction of the front pillars 5AL and 5AR. As shown in FIGS. 28 and 29, the airbag cover 114 is integral with a cowl louver 7b. The airbag cover 114 covers the emergence opening 110a of the case 110 and includes a door 114a which is openable when pushed by the airbag 117 upon deployment.

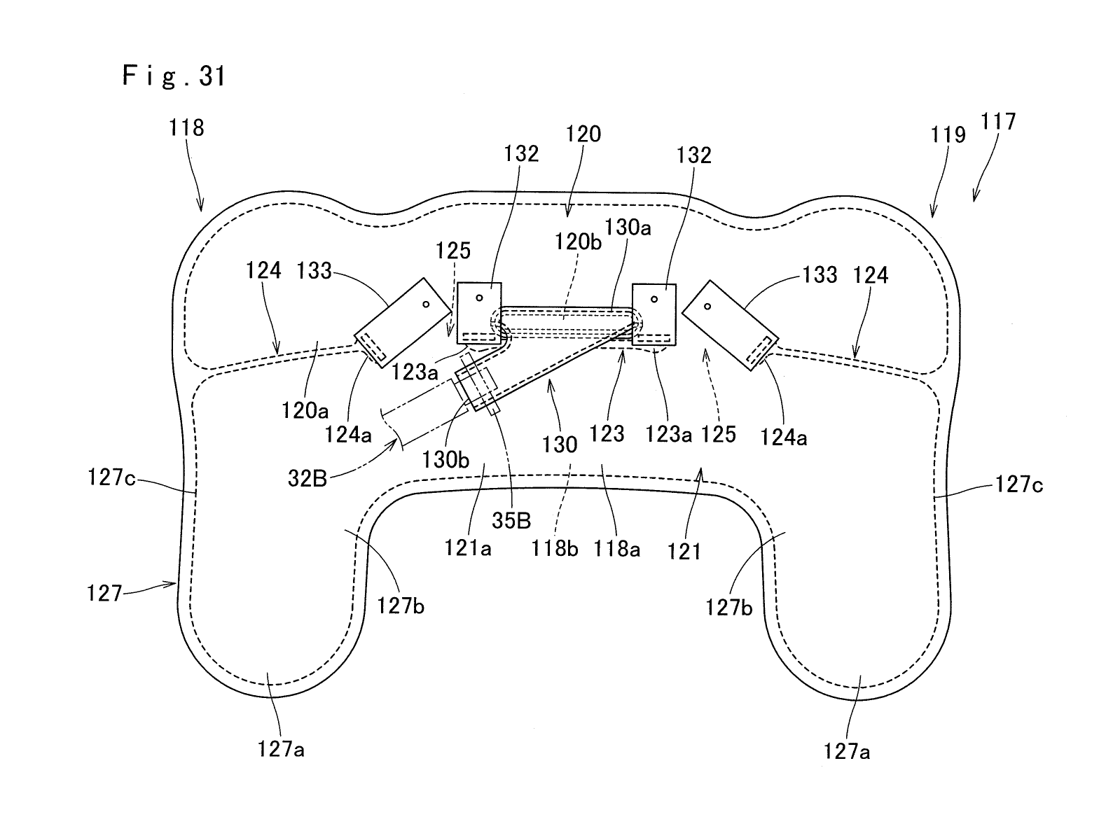

Referring to FIGS. 30 to 33, the airbag 117 includes a bag body 118 inflatable with an inflation gas, a gas inlet portion 130 protruding out of the underside of the bag body 118 for connection with the inflator 32B, mounting portions 132 and mounting portions 133 both of which serve to mount the bag body 118 on the case 110.

As shown in FIGS. 27 and 30, the bag body 118 is inflatable into a generally U shape elongated in a left and right direction as viewed from the front. The bag body 118 includes a horizontal inflatable portion 119 that extends in a left and right direction along a lower region 4a of the front windshield 4 upon deployment and two vertical inflatable portions 127 that extend rearward from opposite ends of the horizontal inflatable portion 119 and cover the front surfaces of the front pillars 5AL and 5AR. In the illustrated embodiment, as shown in FIGS. 30 to 34, the bag body 118 is formed of a lower wall 118a deployable at the lower side and an upper wall 118b deployable at the upper side, which walls 118a and 118b are generally identical in outer contour and are sewn (joined) together by the circumferential edges with sewing threads.

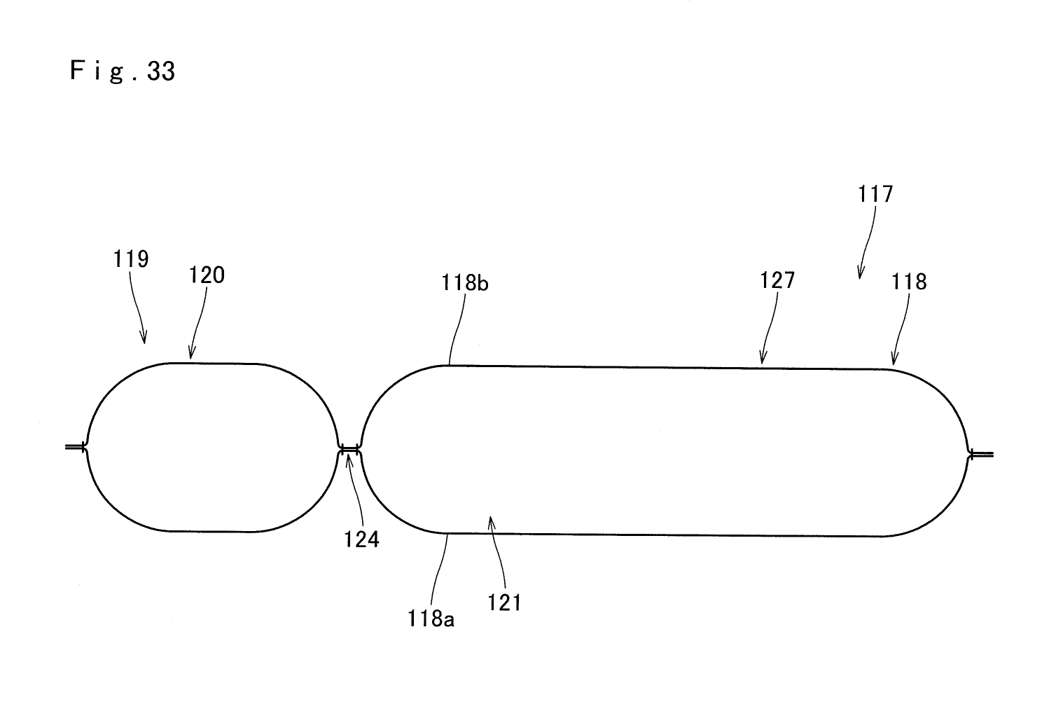

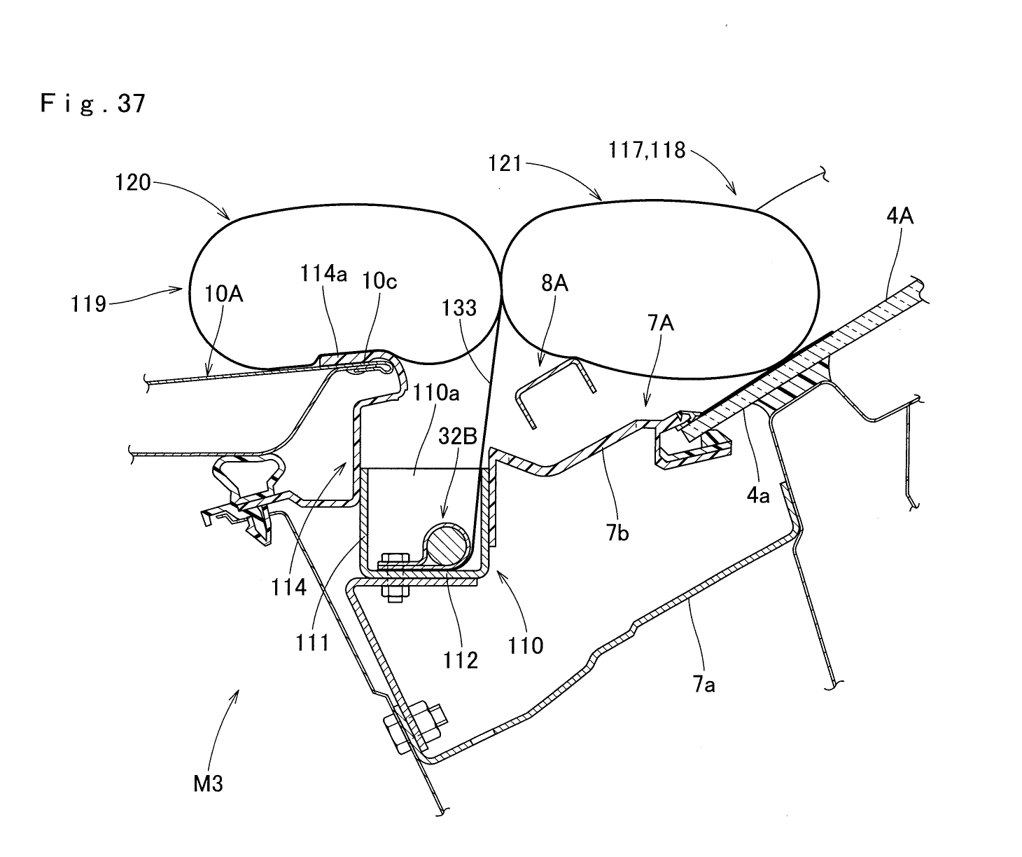

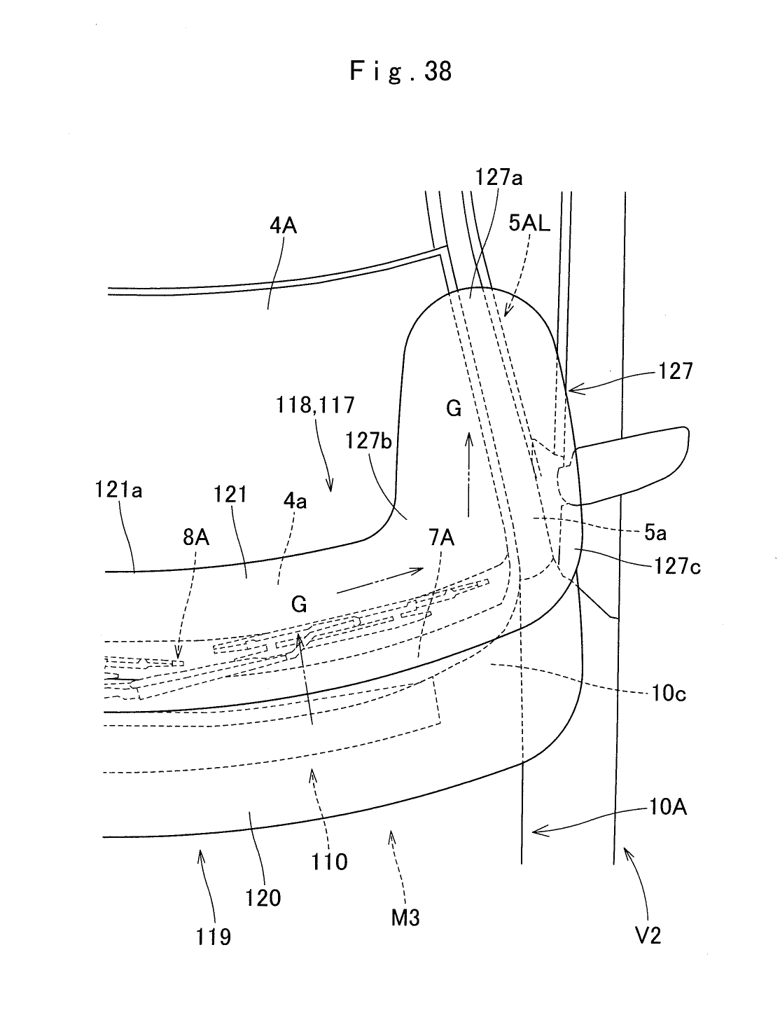

The horizontal inflatable portion 119 is designed to cover upper surfaces of the rear end 10c of the vehicle hood 10A, the cowl 7A and the lower region 4a of the front windshield 4A, including the wipers 8A, as shown in FIGS. 27, 37 and 38. More specifically, the horizontal inflatable portion 119 includes a front region 120 that is deployable to cover the upper surface of the rear end 10c of the vehicle hood 10A and a rear region 121 that is located at the rear of the front region 120 and is deployable to cover the upper surfaces of the cowl 7A and the lower region 4a of the front windshield 4A. As shown in FIG. 32, the gas inlet portion 130, which connects the airbag 117 and inflator 32B, extends downwardly from a vicinity of the rear end of the underside of the front region 120 as deployed. The front region 120 is so designed as to emerge from the emergence opening 110a of the case 110 and unfurl forward and cover the rear end 10c of the vehicle hood 10A whereas the rear region 121 emerges from the emergence opening 110a of the case 110 and unfurl rearward and cover the cowl 7A and lower region 4a of the front windshield 4A.

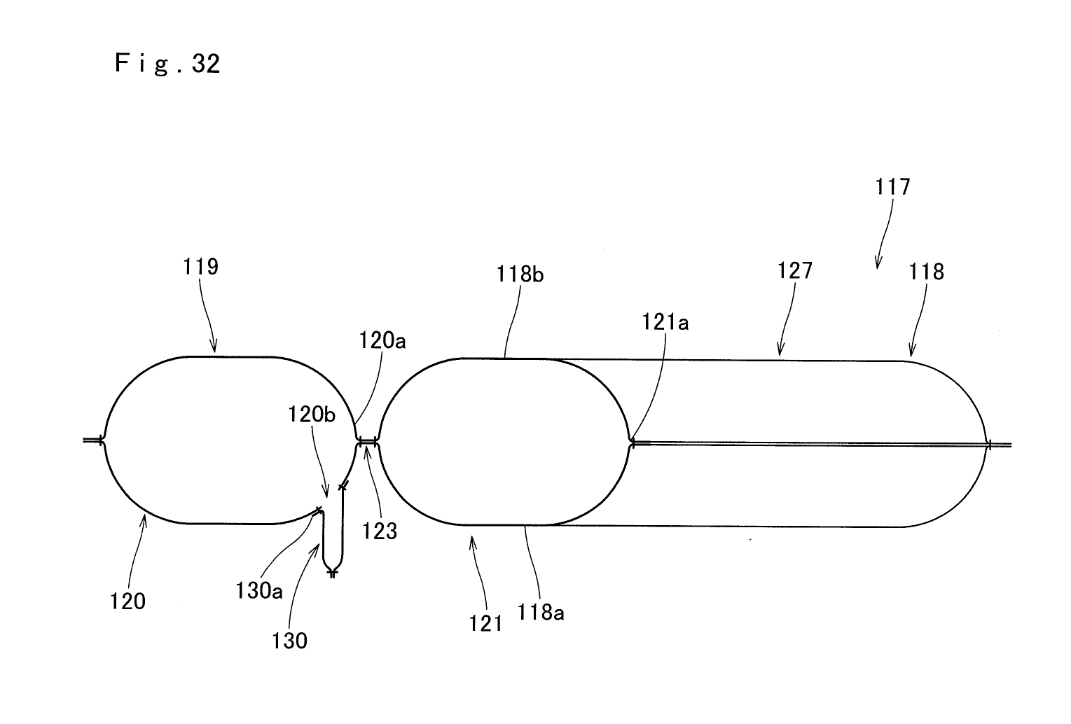

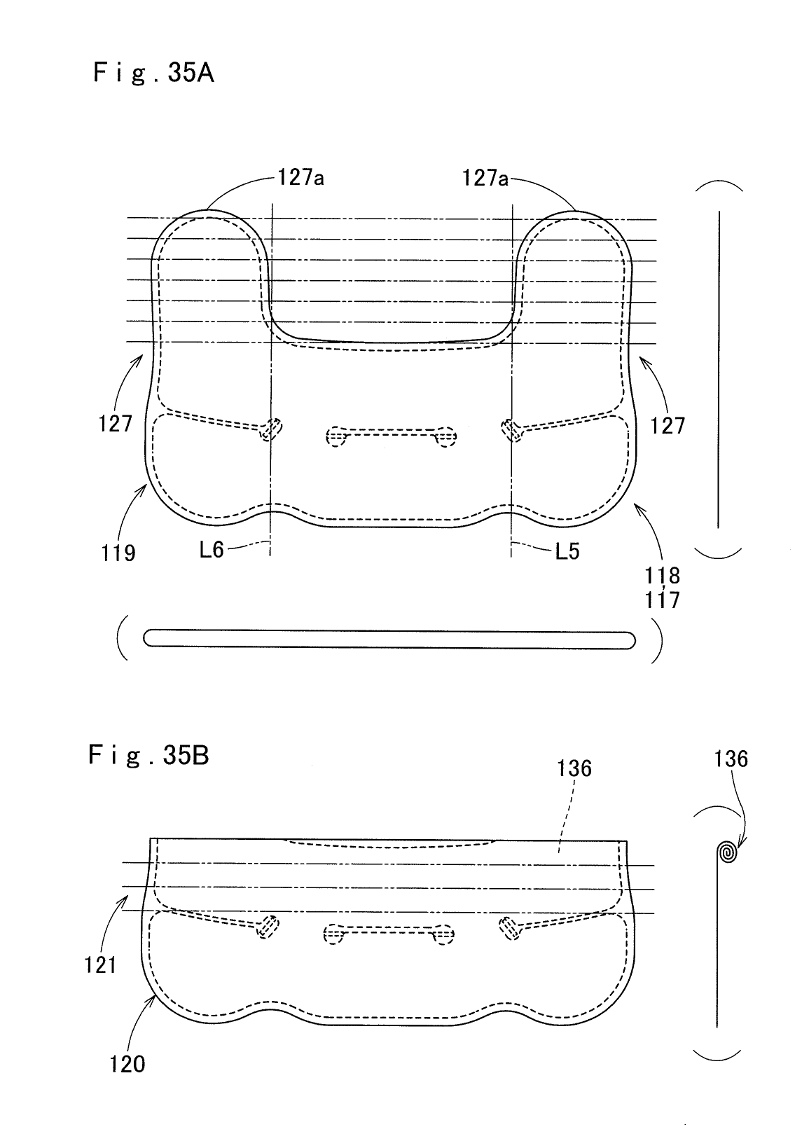

Referring to FIGS. 30, 32 and 33, the front region 120 and rear region 121 are partitioned by a center partitioning portion 123 and a pair of marginal partitioning portions 124 all of which are formed by joining (sewing) the upper wall 118b and lower wall 118b together in an area of the horizontal inflatable portion 119. As shown in FIG. 30, clearances formed between the center partitioning portion 123 and the marginal partitioning portions 124 constitute communication regions 125 that provide communication between the front region 120 and the rear region 121. As shown in FIGS. 31, 32 and 34, the front region 120 includes on the lower wall 118a an opening 120b. The gas inlet portion 130 is joined to the periphery of the opening 120b such that the opening 120b communicates with the gas inlet portion 130. As shown in FIG. 34, the opening 120b is formed into a slot extending in a left and right direction and is located proximate the rear end of and at a generally center in a left and right direction of the front region 120. Specifically, the opening 120b is located right in front of the center partitioning portion 123. With the horizontal inflatable portion 119 of the airbag 117, an inflation gas discharged from the inflator 32B flows into the front region 120 via the gas inlet portion 130 and opening 120b and then flows through the communication regions 125 into the rear region 121. In other words, the front region 120 constitutes an upper reach region which is connected with the inflator 32B and located at the upper reach of a stream of an inflation gas G whereas the rear region 121 constitutes a lower reach region.

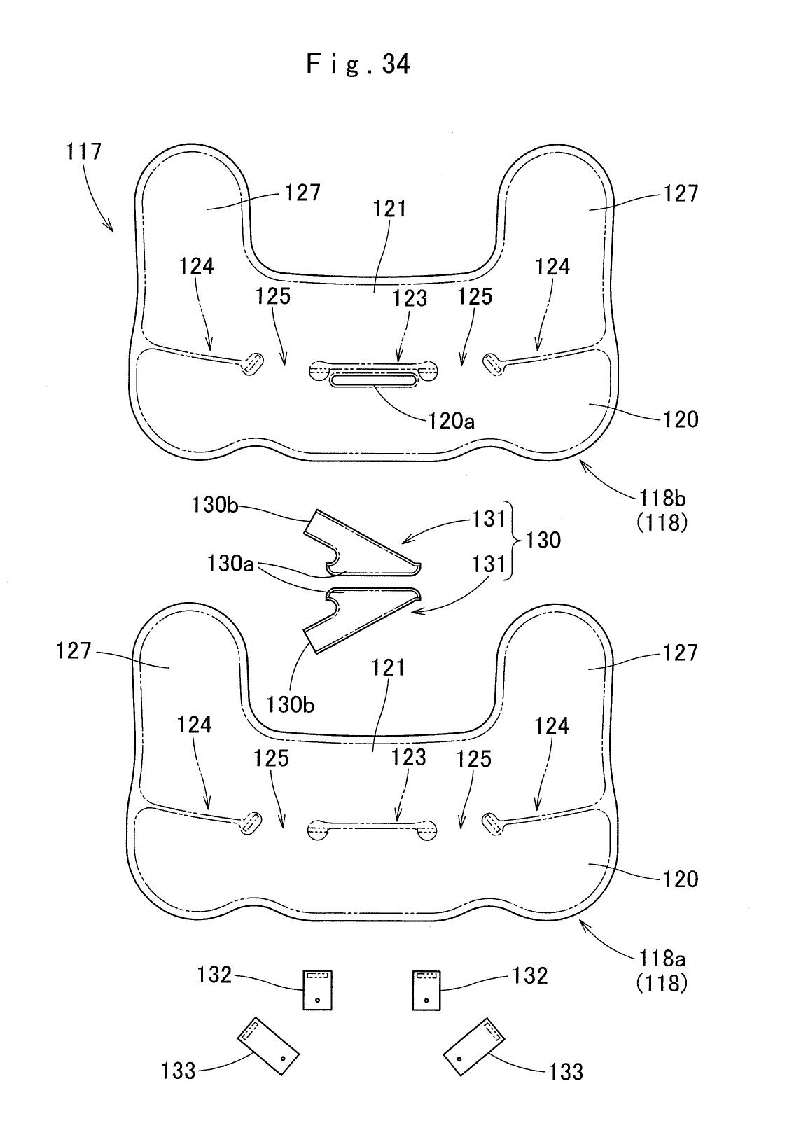

The front region 120 (i.e., the upper reach region) and the rear region 121 (i.e., the lower reach region) have generally the same widths in a front and rear direction when flattened. The marginal partitioning portions 124 are located to the opposite edges of the horizontal inflatable portion 119 in a left and right direction, in front of the vertical inflatable portions 127. As shown in FIGS. 30 and 31, each of the marginal partitioning portions 124 extends inwardly from the peripheral joint (reference numeral omitted) that sews peripheral edges of the upper wall 118b and lower wall 118a together, generally along a left and right direction. Terminals 124a of the marginal partitioning portions 124 are located inward relative to the vertical inflatable portions 127 in a left and right direction. In other words, as shown in FIG. 33, the front region 120 is closed off to the vertical inflatable portions 127 at the regions located in front of the vertical inflatable portions 127 by the marginal partitioning portions 124. More specifically, the terminals 124a of the marginal partitioning portions 124 protrude up to inward positions in a left and right direction relative to the vertical inflatable portions 127, as shown in FIG. 30. Further, each of the terminals 124a of the marginal partitioning portions 124 is formed into a generally thick oval in order to prevent stress concentration upon airbag inflation. The center partitioning portion 123 is located inward of the marginal partitioning portions 124 and right at the rear of the opening 120b of the front region 120. In the illustrated embodiment, the length of the center partitioning portion 123 is greater than an opening width of the opening 120b as shown in FIG. 34 so as to extend outwardly relative to the left and right ends of the opening 120b. Terminals 123a of the center partitioning portion 123 are also formed into thick ovals in order to prevent stress concentration upon airbag inflation. The two communication regions 125 comprised of clearances formed between the marginal partitioning portions 124 and center partitioning portion 123 serve as a gas outlet region that lets out an inflation gas G from the front region 120 (as the upper reach region) toward the rear end 121a of the rear region 121 (as the lower reach region). An opening length of each of the communication regions 125 as the airbag is flattened is about two third of the width in a front and rear direction of the rear region 121. The communication regions 125 are respectively located at the rear edge 120a of the front region 120 as inflated and inward relative to the vertical inflatable portions 127 in a left and right direction, and let out an inflation gas toward the rear edge 121a of the rear region 121.

The vertical inflatable portions 127 are deployable over the front surfaces of the front pillars 5AL and 5AR. The width in a left and right direction of each of the vertical inflatable portions 127 in a flattened state is slightly greater than the width in a front and rear direction of the front region 120 or rear region 121 of the horizontal inflatable portion 119 in a flattened state. More specifically, each of the vertical inflatable portions 127 is so sized in length as to cover generally entire front surfaces of the front pillars 5AL and 5AR.

The gas inlet portion 130 of the third embodiment is provided separate from the bag body 118 and formed into a generally tube. As shown in FIGS. 31, 32 and 34, the root region 130a of the gas inlet portion 130 is entirely joined (or sewn) to the periphery of the opening 120b formed on the lower wall 118a of the front region 120 of the horizontal inflatable portion 119. The gas inlet portion 130 extends obliquely relative to a front and rear direction such that the leading end 130a to be connected with the inflator 32B is directed toward the right. As shown in FIG. 34, the gas inlet portion 130 of the illustrated embodiment is formed by jointing (or sewing) outer peripheral edges of a pair of identical base cloths 131 together.

As shown in FIG. 31, the mounting portions 132 and mounting portions 133 for mounting the bag body 118 on the case 110 are formed into generally bands and extend forward from the rear edge 120a of the front region 120 on the underside (i.e., on the lower wall 118a) of the bag body 118. In the illustrated embodiment, the mounting portions 132 are so joined by the root regions to the left and right ends 123a of the center partitioning portion 123 as to extend forward. The mounting portions 133 are joined by the root regions to the terminals 124a of the marginal partitioning portions 124 in such a manner as to extend obliquely relative to a front and rear direction, thus the respective leading ends are directed inward in a left and right direction. The mounting portions 132 and mounting portions 133 are mounted on the bottom wall 112 of the case 110 with bolts 34B, which are used for fixing the inflator 32B to the case 110, and other fixing means like bolts.

The bag body 118, gas inlet portion 130, mounting portions 132 and 133 of the airbag 117 are also made of a fabric woven of polyester yarn, polyamide yarn or the like and coated with a coating agent for preventing gas leakage.

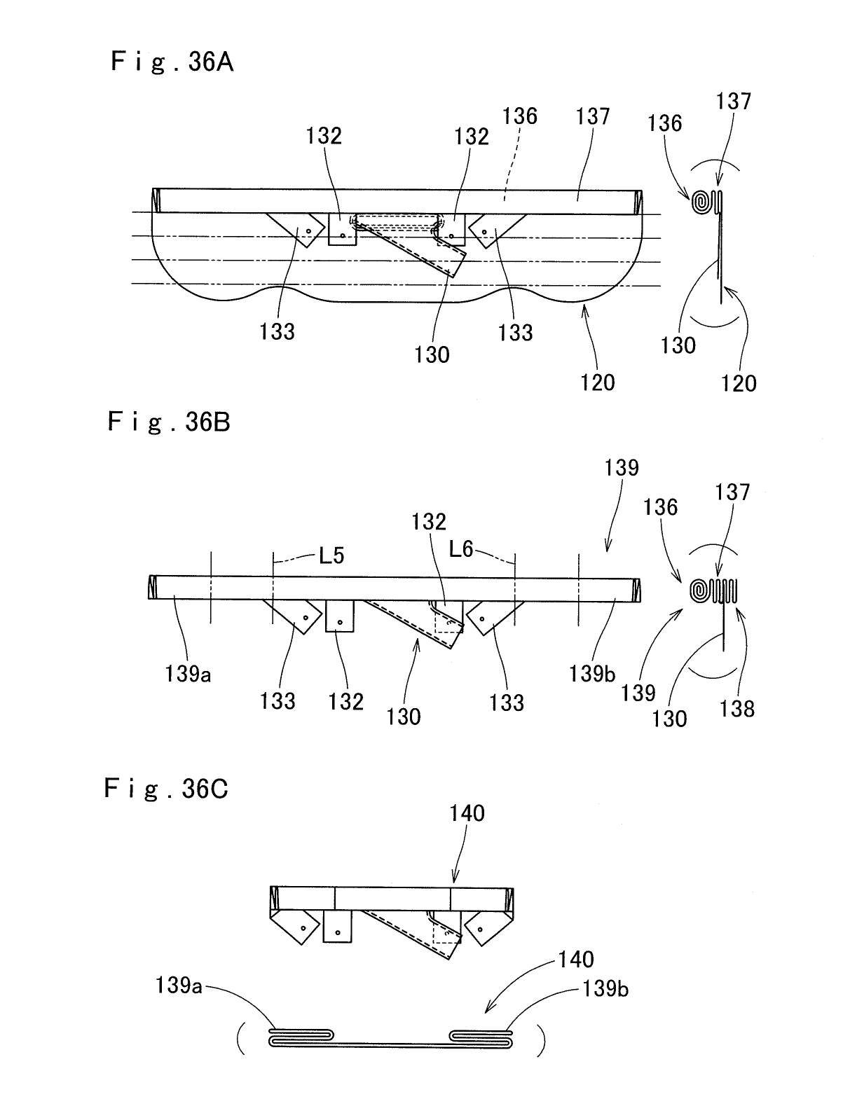

The mounting of the airbag device M3 of the third embodiment on a vehicle V2 is now described. Firstly, the airbag 117 is folded up for storage in the case 110. As shown in FIG. 35A, the airbag 117, so flattened that the upper wall 118b and lower wall 118a overlap with each other, is folded up through the front-rear contraction step, which reduces the width in a front and rear direction, and the left-right contraction step, which reduces the width in a left and right direction. In the front-rear contraction step, as shown in FIG. 35A, firstly, the vertical inflatable portions 127 are rolled on the lower wall 118a from the leading ends 127a, thereby forming a rolled portion 136, as shown in FIG. 35B. Then the rear region 121 of the horizontal inflatable portion 119 is folded in a bellows fashion on creases extending along a left and right direction, thereby forming a bellows-folded portion 137, as shown in FIGS. 35B and 36A. Subsequently, as shown in FIGS. 36A and 36B, the front region 120 of the horizontal inflatable portion 119 is folded in a bellows fashion on creases extending along a left and right direction and brought close to the bellows-folded portion 137, thereby forming a bellows-folded portion 138. Thus the front-rear contraction step is completed. The airbag in this state is referred to as a front-rear contracted bag 139. The left-right contraction step is conducted by folding the front-rear contracted bag 139 on creases L5 and L6 extending along a front and rear direction, as shown in FIG. 36B, at the positions located inside of the vertical inflatable portions 127 and outside of the mounting portions 133, i.e., outside of the communication regions 125, in a left and right direction. Specifically, the left and right end regions 139a and 139b of the front-rear contracted bag 139 are once folded on the creases L5 and L6 towards the center in a left and right direction and then again folded outward, i.e., in a bellows fashion. Thus the left-right contraction step is completed as shown in FIG. 36C and a completely-folded body 140, which fits in the case 110, is provided.

The folded-up airbag 117 is connected to the inflator 32B and set in the case 110. If the case 110 is mounted on the cowl panel 7a and the cowl louver 7b is mounted thereon, the airbag device M3 is mounted on the vehicle V2. The airbag device M3 of the third embodiment is actuated when an actuating circuit (not shown) detects an impact between the vehicle V2 and a pedestrian in response to a signal fed from a sensor (not shown) mounted on a front bumper 6A. When actuated, the inflator 32B feeds an inflation gas to the airbag 117 and the airbag 117 inflates and pushes and opens the door 114a of the airbag cover 114. Then the airbag 117 emerges from the emergence opening 110a of the case 110 formed by opening of the door 114a and deploy upward, thus covers the upper surfaces of the rear end 10c of the vehicle hood 10A and cowl 7A and front surfaces of the front pillars 5AL and 5AR (FIGS. 27, 37 and 38).

In operation, in an initial stage of airbag inflation, an inflation gas G fed from the inflator 32B inflates firstly the front region 120 of the horizontal inflatable portion 119 (i.e., the upper reach region), and then flows into the rear region 121 (i.e., the lower reach region) of the horizontal inflatable portion 119 via the communication regions 125 (i.e., the gas outlet region) formed on the rear edge 120a of the front region 120, and then flows into and inflates the vertical inflatable portions 127. The communication regions 125 (i.e., gas outlet region), which let out an inflation gas towards the rear region 121 (i.e., lower reach region), are located inward relative to the vertical inflatable portion 127 in a left and right direction at the rear edge 120a of the front region 120 (i.e., upper reach region). Moreover, the communication regions 125 are so designed as to feed an inflation gas G toward the rear edge 121a of the rear region 121.

With this configuration, an inflation gas G discharged from the inflator 32B will once fill up the front region 120 of the horizontal inflatable portion 119 and then flow into the rear region 121 via the communication regions 125 and flow toward the rear edge 121a of the rear region 121. When the gas G hits the rear edge 121a of the rear region 121, it will be redirected toward left and right directions and flow through the rear region 121 towards left and right, then flow into the vertical inflatable portions 127. When the gas G flows into the vertical inflatable portions 127, it will hit the outer edges 127c, i.e., the left and right ends, of the vertical inflatable portions 127, and be redirected again rearward at the root regions 127b of the vertical inflatable portions 127, then flow into the vertical inflatable portions 127.

That is, the configuration of the airbag device M3 of the third embodiment will help prevent an inflation gas G from flowing into the vertical inflatable portions 127 in back and outward directions, and the gas G will flow into the vertical inflatable portions 127 after being redirected in stages while flowing through the front region 120 (i.e., the upper reach region) and rear region 121 (i.e., the lower reach region). When the gas G reaches the vertical inflatable portions 127, it will bulge the root regions 127b firstly and flow through the vertical inflatable portions 127 rearward, with the outward directionality suppressed. Accordingly, the vertical inflatable portions 127 will be prevented from oscillating in a left and right direction during deployment, and deploy over the front surfaces of the front pillar 5AL and 5AR in a quick and steady fashion.

Therefore, the airbag device M3 of the third embodiment is capable of deploying the vertical inflatable portions 127 located on the opposite ends of the horizontal inflatable portion 119 over the front surfaces of the front pillars 5AL and 5AR in a quick and steady fashion.

Also in the third embodiment, the airbag 117 is folded up through the front-rear contraction step and the left-right contraction step. In the front-rear contraction step, the vertical inflatable portions 127 as flattened are rolled on the lower wall 118a from the rear ends or leading ends 127a, and in the left-right contraction step, the left and right ends 139a and 139b of the front-rear contracted bag 139 are brought close to the center in a left and right direction such that the vertical inflatable portions 127 are folded back toward the horizontal inflatable portion 119. This configuration will enable the airbag 117 to undo the left-right contraction and unfurl the vertical inflatable portions 127 quickly towards left and right in an initial stage of airbag inflation, and the vertical inflatable portions 127 will roll out along the front surfaces of the front pillars 5AL and 5AR when unrolling, rather than oscillating or floating up from the front pillars 5AL and 5AR while unfurling. Consequently, the vertical inflatable portions 127 will deploy quickly over the front pillars 5AL and 5AR.

In this specification, the airbag devices M1 and M2 in the first and second embodiments have been described as mounted on a vehicle V1 provided with an actuator 21 for lifting up the rear end 10c of the vehicle hood 10 whereas the airbag device M3 in the third embodiment has been described as mounted on a vehicle V2 which is not provided with such an actuator. However, the airbag devices M1 and M2 may also be mounted on a vehicle without an actuator such that the rear end of the vehicle hood will be pushed up by an inflating airbag. The airbag devices M1 and M2 in the first and second embodiments are mounted on the underside of a vehicle hood and the airbag device M3 of the third embodiment is mounted on a cowl. However, the mounting location of the airbag device of the invention should not be limited thereby. By way of example, an airbag device like the airbag device M1 or M2 may also be mounted on a cowl whereas an airbag device like the airbag device M3 may also be located in a concave region formed on a top surface of the rear end of a vehicle hood.

What is claimed is:

1. A pedestrian protection airbag device adapted to be mounted on a vehicle, comprising:
an airbag housed in a housing that is adapted to be mounted proximate to a rear end of a vehicle hood and proximate to a center of a space between front pillars, the airbag being folded up in front and rear- and left and right directions;
a horizontal inflatable portion of the airbag that is deployable into a generally rod shape extending in a left and right direction over a lower region of a front windshield located at the rear of the vehicle hood;
a pair of vertical inflatable portions of the airbag that extend rearward from opposite ends of the horizontal inflatable portion for covering front surfaces of the front pillars, each of the vertical inflatable portions being folded back toward the horizontal inflatable portion when the airbag is folded up to be housed in the housing;
an inflator that is connected with a front side of the horizontal inflatable portion for feeding an inflation gas to the airbag;
an upper reach region of the horizontal inflatable portion that is located in a front region of the horizontal inflatable portion as inflated, the upper reach region being connected to the inflator and located at an upper reach of a stream of an inflation gas;
a lower reach region of the horizontal inflatable portion that is deployable at the rear of the upper reach region; and
a gas outlet region that is located at a rear edge of the upper reach region as inflated and inward relative to the vertical inflatable portions in a left and right direction for letting out an inflation gas toward a rear edge of the lower reach region, such that an inflation gas having flown out of the upper reach region via the gas outlet region flows through the lower reach region and then into the vertical inflatable portions.

2. The pedestrian protection airbag device of claim 1 further comprising:
a tether that extends inside the horizontal inflatable portion over a generally entire length in a left and right direction and partitions an interior of the horizontal inflatable portion into front and rear, such that a region located in front of the tether is the upper reach region whereas a region located at the rear of the tether is the lower reach region; and
a plurality of communication holes that are formed on the tether and constitute the gas outlet region.

3. The pedestrian protection airbag device of claim 2, wherein the communication holes are provided numerously in such a manner as to form double horizontal lines extending across a region located inward relative to the vertical inflatable portions on the tether.

4. The pedestrian protection airbag device of claim 1, further comprising an inner bag that is located toward a front end of and inside of the horizontal inflatable portion, the inner bag serving as the upper reach region and includes at a rear edge thereof as inflated a plurality of outlet holes that serve as the gas outlet region.

5. The pedestrian protection airbag device of claim 4, wherein the outlet holes are provided numerously in such a manner as to form double horizontal lines extending across a region located inward relative to the vertical inflatable portions at the rear edge of the inner bag.

6. The pedestrian protection airbag device of claim 4, wherein left and right ends of the inner bag are located inward relative to the vertical inflatable portions in a left and right direction.

7. The pedestrian protection airbag device of claim 4, wherein:
the inner bag is so designed as to admit an inflation gas from a generally center in a left and right direction of a front edge thereof as inflated; and
the outlet holes are located generally at a center in a left and right direction of a rear edge of the inner bag as inflated.

8. The pedestrian protection airbag device of claim 1, wherein a total opening area of the gas outlet region is generally coincident with a sum of sectional areas of the vertical inflatable portions as fully inflated at vicinities of connecting regions with the horizontal inflatable portion.

9. The pedestrian protection airbag device of claim 1, wherein:
the airbag includes a lower wall deployable at a lower side and an upper wall deployable at an upper side;
the airbag further includes in an area of the horizontal inflatable portion a plurality of partitioning portions that are formed intermittently by joining the lower wall and the upper wall so as to extend in a left and right direction and partition the upper reach region and the lower each region; and
the gas outlet region is comprised of clearances formed between the portioning portions.

10. The pedestrian protection airbag device of claim 1, wherein:
the airbag includes a lower wall deployable at a lower side and an upper wall deployable at an upper side;
the airbag as housed in the housing is folded up, from a flattened state where the upper wall and the lower wall overlap with each other, through a front-rear contraction step which reduces a width of the airbag in a front and rear direction, and a left-right contraction step which reduces a width of the airbag in a left and right direction;
in the front-rear contraction step, at least the vertical inflatable portions are rolled on the lower wall from rear ends thereof; and
in the left-right contraction step, left and right ends of a front-rear contracted bag, which has gone through the front-rear contraction step, are brought close to a center in a left and right direction of the airbag such that the vertical inflatable portions are folded back on the horizontal inflatable portion.
